(19) United States
(12) Patent Application Publication
(10) Pub. No.: US 2017/0120220 A1
(43) Pub. Date: May 4, 2017

(54) OPTICAL MEMBER AND METHOD FOR PRODUCING SAME

(71) Applicant: NATIONAL INSTITUTE OF ADVANCED INDUSTRIAL SCIENCE AND TECHNOLOGY, Tokyo (JP)

(72) Inventors: Hiromichi WATANABE, Ibaraki (JP); Juntaro ISHII, Ibaraki (JP); Keishin OTA, Ibaraki (JP)

(21) Appl. No.: 15/374,650

(22) Filed: Dec. 9, 2016

Related U.S. Application Data
(63) Continuation of application No. PCT/JP2015/066116, filed on Jun. 3, 2015.

(30) Foreign Application Priority Data
Jun. 12, 2014 (JP) 2014-121875
Jan. 30, 2015 (JP) 2015-016862

(51) Int. Cl. B01J 21/18; B01J 35/00; B01J 35/02; B01J 21/04

(52) U.S. Cl. CPC B01J 21/18; B01J 21/04; B01J 35/0006; B01J 35/026; C01B 31/0233; B82Y 40/00

(57) ABSTRACT

An optical member related to the present application includes a metal substrate or inorganic carbon substrate having a rough surface on at least a part, and the metal substrate or inorganic carbon substrate does not melt at a growth temperature of a carbon nanostructure, an inorganic material layer containing inorganic fine particles comprised from a metal oxide and the inorganic material layer being formed on the rough surface of the metal substrate or the inorganic carbon substrate; a catalyst metal fine particle layer supported on the inorganic material layer; and a carbon nanostructure formed on the catalyst metal fine particle layer. The material of the metal substrate may be a metal selected from a group comprising of Ti, Zr, Hf, V, Nb, Ta, Cr, Mo, W, Pd, Pt, Cu, Au and Ag or an alloy of these as a main component, an isotropic graphite or glassy carbon.

### CROSS REFERENCE TO RELATED APPLICATIONS

This application is based upon and claims the benefit of priority from the prior Japanese Patent Application No. 2014-121875, filed on Jul. 12, 2014, and the prior Japanese Patent Application No. 2015-016862, filed on Jan. 30, 2015, and PCT Application No. PCT/JP2015/066116, filed on Jun. 3, 2015, the entire contents of which are incorporated herein by reference.

### FIELD

The present invention is related to an optical member and method for producing the same. In particular, the present invention is related to an optical member using high emissivity a carbon nanostructure and a method for producing the same.

### BACKGROUND

An optical member having high emissivity is required for a wide range of uses such as microscopes, cameras, measuring apparatus, heat dissipation components, blackbody furnaces, standard reflectors and heaters for example. Various techniques have been proposed for a surface treatment technique to approximate the emissivity (the absorption rate) of a surface to 1 by growing a carbon material layer (hereinafter, also referred to as carbon nanostructure) having a fibrous and fine structure such as carbon nanotubes (CNT) and carbon nanofibers (CNF) on a surface of a metal or carbon material in order to significantly contribute to improving the performance of an irregular reflection prevention coating within an optical device, a heat dissipation component, and blackbody furnace and the like.

For example, an optical member (electromagnetic wave radiator and the electromagnetic wave absorber) having a high emissivity in a wide wavelength range and a producing method thereof is described in Japanese Laid Open Patent Publication No. 2010-192581 in which a carbon nanotube vertically aligned aggregate (hereinafter, referred to as CNT aggregate) having a bulk density of an object surface of 0.002 to 0.2 g/cm³ and a thickness of 10 μm or more is grown using one type of chemical vapor deposition (hereinafter, also referred to as a CVD method).

A CNT aggregate having high emissivity is also described in a non-patent document described in Japanese Laid Open Patent Publication No. 2010-192581. In Japanese Laid Open Patent Publication No. 2010-192581, since single-walled carbon nanotubes are grown on an object in vertically aligned state at a high density, there is concern that the surface emissivity (absorption rate) has an angular anisotropy due to light interference effects arising from structural regularity, and the development of an optical member having a high emissivity in all directions is desired. However, the prior art has the following four problems.

Although a general method of growing a CNT or CNF on the surface of an object is a CVD method utilizing thermal decomposition of a hydrocarbon as described above, it is necessary to disperse and fix fine particles of an iron-based transition metal (Fe, Ni, Co etc) as a catalyst onto a substrate to make a carbon material into a film in order to grow a carbon material having a nanostructure. In a high temperature holding state during CVD, in order to prevent alloying of a substrate and a catalyst metal or coarsening of catalyst metal fine particles, it is necessary to form a thin film of inorganic material having numerous small voids as a catalyst support layer on the substrate surface. As a method for forming such an inorganic thin film, a method for forming a thin film of an oxide such as alumina by sputtering, or a method for obtaining an oxide thin film by an oxidation treatment after forming a metal film such as aluminum which is easily oxidized by sputtering or a vacuum deposition method is generally employed. For example, an alumina thin film in particular being effective as a catalyst support layer for growing an elongated CNT is shown experimentally in S. Noda et al., Japanese Journal of Applied Physics, 46, L399-401 (2007).

In addition, it is also common to form a catalyst metal as a thin film on a substrate surface similarly by sputtering or vacuum deposition. However, in sputtering or vacuum evaporation method, uniformly depositing on a surface of an object having a cavity which exists as an obstacle between the depositing source and film or complex three-dimensional curved surface cannot be performed, and there is a limit to the size of the object that the film can be formed due to the size of a chamber of a device and deposition source. In addition, although it can be said that the producing process itself of a carbon nanostructure by a CVD method is inexpensive and has high productivity, the cost of multiple processes to form the film which are performed as a pretreatment of a substrate lead to a steep rise in the price of application products.

On the other hand, a technique for film formation of a CNT on a surface of a metal three-dimensional object by a CVD method without using a film formation process by sputtering or a vacuum deposition method, for example, is introduced in L. Randall et al., Carbon, 41, 659-672 (2003) and Talapatra et al., Nature Nanotechnology, 1, 112-116 (2006). As part of the application of a CNT, a method of directly growing a CNT on a surface of a wire mesh made of stainless steel (SUS304) by a CVD method is described in L. Randall et al., Carbon, 41, 659-672 (2003). Focusing on stainless steel containing iron which is a representative catalyst of a CNT, the minute sites of iron in a stainless steel surface becoming the sites for the generation of a CNT, and being able to form a film of multilayer CNTs on the entire surface of the stainless steel wire mesh using a CVD method with acetylene and benzene as raw materials is described in L. Randall et al., Carbon, 41, 659-672 (2003).

A method of growing a CNT by a CVD method without forming a catalyst support layer of an oxide on a surface of an alloy object with Ni in a three-dimensional shape as the main component is described in Talapatra et al., Nature Nanotechnology, 1, 112-116 (2006). Depositing catalyst iron fine particles on the entire surface of a variety of three-dimensional shaped objects by introducing ferrocene vapor which is a type of iron metal complex to a CVD reactor furnace, and being able to form a film of multilayer CNTs on a surface of a three-dimensional object made from heat-resistant alloy (Inconel) with Ni as the main component is described in Talapatra et al., Nature Nanotechnology, 1, 112-116 (2006).

Experimental results showing that it is possible to directly film form a CNT on a surface of an alloy containing an iron-based transition metal which is a representative catalyst metal of a CNT without forming a catalyst support layer are reported in L. Randall et al., Carbon, 41, 659-672 (2003) and Talapatra et al., Nature Nanotechnology, 1, 112-116 (2006). Although Talapatra et al., Nature Nanotechnology, 1, 112-116 (2006) describes the possibility of applying this method to a certain type of alloys containing two or more metal elements such as Al, Cu, Co, Cr, Fe, Ni, Pt, Ta, Ti, and Zn and not limited to an iron-based transition metal, the basis of this is not fully described. Therefore, in these conventional techniques, not being able to be applied to a pure metal or carbon material or not being able to clearly specify an alloy composition which can be applied other than an alloy containing an iron-based transition metal is a problem.

Although it is necessary to uniformly grow a carbon nanostructure over the entire surface of an object in many applications in order to use an object grown with a CNT or CNF on the surface as an optical element with radiation or absorption of electromagnetic wave as the goal, the generation of streaky and island-shaped defect parts was a problem in the conventional CVD method. Although the cause for defect parts occurring is not clear, it is thought that they are due to a reaction occurring between contaminants in a substrate and a catalytic metal or due to a defect of a catalyst support layer or an inappropriate continuous film structure for a catalyst support.

A growing method of a carbon nanostructure using a conventional CVD method is generally performed by introducing hydrogen gas as a reducing agent together with hydrocarbon gas as a raw material for a carbon nanostructure in order to maintain activity of a catalyst metal. However, since a phenomenon (hydrogen embrittlement) occurs whereby hydrogen enters between metal atoms when metal is exposed to a high temperature hydrogen atmosphere, in the case where metal is selected as a substrate for growing carbon nanostructures, it is originally desired to avoid use of hydrogen. Since carbon nanostructures are produced by a thermal decomposition reaction of hydrocarbon which is the raw material, hydrogen or water produced by reaction of hydrogen and oxygen as a byproduct. Therefore, in the case where the concentration within a reaction system of hydrogen which is a byproduct increases, since the reaction proceeds in the direction where a thermal decomposition reaction of the hydrocarbon is inhibited as can be seen from Le Chatelier's principle, the introduction of hydrogen is considered to be thermodynamically disadvantageous to thermal decomposition of hydrocarbons. Although carbon monoxide sometimes is used as a reducing gas other than hydrogen in order to avoid such problems, carbon monoxide has a problem of safety during operation since it is a toxic gas.

### SUMMARY

The present invention has been made to solve the problems of the conventional technique described above by providing an optical member and a producing method thereof which uniformly grows a carbon nanostructure on a surface of an object without being restricted as compared with the conventional method with respect to the material and shape of the object for forming a film of a carbon nanostructure.

According to one embodiment of the present invention, an optical member is provided including a metal substrate or inorganic carbon substrate having a rough surface on at least a part, and the metal substrate or inorganic carbon substrate does not melt at a growth temperature of a carbon nanostructure, an inorganic material layer containing inorganic fine particles comprised from a metal oxide and the inorganic material layer being formed on the rough surface of the metal substrate or the inorganic carbon substrate; a catalyst metal fine particle layer supported on the inorganic material layer; and a carbon nanostructure formed on the catalyst metal fine particle layer.

In the optical member, a material of the metal substrate may be a metal selected from a group comprising of Ti, Zr, Hf, V, Nb, Ta, Cr, Mo, W, Pd, Pt, Cu, Au and Ag or an alloy of these as a main component, and a material of the inorganic carbon substrate is an isotropic graphite or glassy carbon.

In the optical member, the inorganic material layer may include an oxide film of a metal substrate itself formed in the metal substrate.

In the optical member, spectral emissivity in the visible wavelength range may be 0.99 or more, and spectral emissivity in the infrared wavelength range may be 0.98 or more.

In addition, according to one embodiment of the present invention, a producing method for an optical member is provided including forming a rough surface by colliding inorganic fine particles comprising a metal oxide using an aerodynamic or projection method on at least a part of a metal substrate or inorganic carbon substrate which does not melt at a growth temperature of a carbon nanostructure, and forming an inorganic layer on the rough surface of the metal substrate or inorganic carbon substrate; forming a catalyst metal fine particle layer on the inorganic layer; and forming a carbon nanostructure on the catalytic metal fine particle layer.

In addition, according to one embodiment of the present invention, a producing method for an optical member is provided including forming a rough surface by colliding inorganic fine particles comprising a metal oxide using an aerodynamic or projection method on at least a part of a metal substrate or inorganic carbon substrate which does not melt at a growth temperature of a carbon nanostructure; forming an inorganic material layer mixed with an oxide film of the metal substrate itself and an inorganic fine particle layer; forming a catalyst metal fine particle layer on the inorganic layer; and forming a carbon nanostructure on the catalyst metal fine particle layer.

In a producing method for the optical member, the catalyst metal fine particle layer may be formed by supplying a vapor containing catalyst metal fine particles generated by heating a metal complex.

### BRIEF DESCRIPTION OF DRAWINGS

FIG. 1 is a schematic diagram showing an optical member 100 in one embodiment of the present invention;

FIG. 2A is a schematic diagram showing a method for producing an optical member 100 according to one embodiment of the present invention;

FIG. 2B is a schematic diagram showing a method for producing an optical member 100 according to one embodiment of the present invention;

FIG. 2C is a schematic diagram showing a method for producing an optical member 100 according to one embodiment of the present invention;

FIG. 2D is a schematic diagram showing a method for producing an optical member 100 according to one embodiment of the present invention;

FIG. 3A is a schematic diagram showing a method for producing an optical member 200 according to one embodiment of the present invention;

FIG. 3B is a schematic diagram showing a method for producing an optical member 200 according to one embodiment of the present invention;

FIG. 3C is a schematic diagram showing a method for producing an optical member 200 according to one embodiment of the present invention;

FIG. 3D is a schematic diagram showing a method for producing an optical member 200 according to one embodiment of the present invention;

FIG. 3E is a schematic diagram showing a method for producing an optical member 200 according to one embodiment of the present invention;

FIG. 4 is a schematic diagram of an optical member 200 according to one embodiment of the present invention;

FIG. 5 is an electron microscope (SEM) image of inorganic fine particles (alumina powder) according to one example of the present invention;

FIG. 6A is a two-dimensional electron image photograph including AES measurement sections of a W substrate according to one example of the present invention;

FIG. 6B is a two-dimensional electron image photograph including AES measurement sections of a W substrate according to one example of the present invention;

FIG. 6C is a two-dimensional electron image photograph including AES measurement sections of a W substrate according to one example of the present invention;

FIG. 6D is a two-dimensional electron image photograph including AES measurement sections of a W substrate according to one example of the present invention;

FIG. 7 is a diagram showing an Auger spectrum of the outermost surface of the W substrate according to one example of the present invention;

FIG. 8A is a two-dimensional electron image photograph including AES measurement sections of a Ti substrate according to one example of the present invention;

FIG. 8B is a two-dimensional electron image photograph including AES measurement sections of a Ti substrate according to one example of the present invention;

FIG. 8C is a two-dimensional electron image photograph including AES measurement sections of a Ti substrate according to one example of the present invention;

FIG. 9 is a diagram showing an Auger spectrum of the outermost surface of the Ti substrate according to one example of the present invention;

FIG. 10A is a two-dimensional electron image photograph including AES measurement sections of a Cr substrate according to one example of the present invention;

FIG. 10B is a two-dimensional electron image photograph including AES measurement sections of a Cr substrate according to one example of the present invention;

FIG. 10C is a two-dimensional electron image photograph including AES measurement sections of a Cr substrate according to one example of the present invention;

FIG. 11 is a diagram showing an Auger spectrum of the outermost surface of the Cr substrate according to one example of the present invention;

FIG. 12A is a two-dimensional electron image photograph including AES measurement sections of a Cu substrate according to one example of the present invention;

FIG. 12B is a two-dimensional electron image photograph including AES measurement sections of a Cu substrate according to one example of the present invention;

FIG. 12C is a two-dimensional electron image photograph including AES measurement sections of a Cu substrate according to one example of the present invention;

FIG. 13 is a diagram showing an Auger spectrum of the outermost surface of the Cu substrate according to one example of the present invention;

FIG. 14A is a two-dimensional electron image photograph including AES measurement sections of a Zr substrate according to one example of the present invention;

FIG. 14B is a two-dimensional electron image photograph including AES measurement sections of a Zr substrate according to one example of the present invention;

FIG. 14C is a two-dimensional electron image photograph including AES measurement sections of a Zr substrate according to one example of the present invention;

FIG. 15 is a diagram showing an Auger spectrum of the outermost surface of the Zr substrate according to one example of the present invention;

FIG. 16A is a two-dimensional electron image photograph including AES measurement sections of a Pt substrate according to one example of the present invention;

FIG. 16B is a two-dimensional electron image photograph including AES measurement sections of a Pt substrate according to one example of the present invention;

FIG. 16C is a two-dimensional electron image photograph including AES measurement sections of a Pt substrate according to one example of the present invention;

FIG. 17 is a diagram showing an Auger spectrum of the outermost surface of the Pt substrate according to one example of the present invention;

FIG. 18A is a diagram showing a SEM image of the outermost surface of the Cu substrate according to one example of the present invention;

FIG. 18B is a diagram showing a surface distribution of Al on the outermost surface of the Cu substrate according to one example of the present invention;

FIG. 18C is a diagram showing a surface distribution of Al on the outermost surface of the Cu substrate according to one example of the present invention;

FIG. 19A is a diagram showing a SEM image of the outermost surface of the W substrate according to one example of the present invention;

FIG. 19B is a diagram showing a surface distribution of Al on the outermost surface of the W substrate according to one example of the present invention;

FIG. 19C is a diagram showing a surface distribution of Al on the outermost surface of the W substrate according to one example of the present invention;

FIG. 20A is a diagram showing a SEM image of the outermost surface of the Ti substrate according to one example of the present invention;

FIG. 20B is a diagram showing a surface distribution of Al on the outermost surface of the Ti substrate according to one example of the present invention;

FIG. 20C is a diagram showing a surface distribution of Al on the outermost surface of the Ti substrate according to one example of the present invention;

FIG. 21A is a diagram showing a SEM image of the outermost surface of an isotropic graphite substrate according to one example of the present invention;

FIG. 21B is a diagram showing a surface distribution of Al on the outermost surface of an isotropic graphite substrate according to one example of the present invention;

FIG. 21C is a diagram showing a surface distribution of Al on the outermost surface of an isotropic graphite substrate according to one example of the present invention;

FIG. 21D is a diagram showing a surface distribution of Al on the outermost surface of an isotropic graphite substrate according to one example of the present invention;

FIG. 22A is a SEM image of carbon nanostructures grown on a Ti substrate according to one example of the present invention;

FIG. 22B is a SEM image of carbon nanostructures grown on a Ti substrate according to one example of the present invention;

FIG. 22C is a SEM image of carbon nanostructures grown on a Ti substrate according to one example of the present invention;

FIG. 22D is a SEM image of carbon nanostructures grown on a Ti substrate according to one example of the present invention;

FIG. 23A is a SEM image of carbon nanostructures grown on a Zr substrate according to one example of the present invention;

FIG. 23B is a SEM image of carbon nanostructures grown on a Zr substrate according to one example of the present invention;

FIG. 23C is a SEM image of carbon nanostructures grown on a Zr substrate according to one example of the present invention;

FIG. 23D is a SEM image of carbon nanostructures grown on a Zr substrate according to one example of the present invention;

FIG. 24A is a SEM image of carbon nanostructures grown on a Hf substrate according to one example of the present invention;

FIG. 24B is a SEM image of carbon nanostructures grown on a Hf substrate according to one example of the present invention;

FIG. 24C is a SEM image of carbon nanostructures grown on a Hf substrate according to one example of the present invention;

FIG. 24D is a SEM image of carbon nanostructures grown on a Hf substrate according to one example of the present invention;

FIG. 25A is a SEM image of carbon nanostructures grown on a V substrate according to one example of the present invention;

FIG. 25B is a SEM image of carbon nanostructures grown on a V substrate according to one example of the present invention;

FIG. 25C is a SEM image of carbon nanostructures grown on a V substrate according to one example of the present invention;

FIG. 25D is a SEM image of carbon nanostructures grown on a V substrate according to one example of the present invention;

FIG. 26A is a SEM image of carbon nanostructures grown on an Nb substrate according to one example of the present invention;

FIG. 26B is a SEM image of carbon nanostructures grown on an Nb substrate according to one example of the present invention;

FIG. 26C is a SEM image of carbon nanostructures grown on an Nb substrate according to one example of the present invention;

FIG. 26D is a SEM image of carbon nanostructures grown on an Nb substrate according to one example of the present invention;

FIG. 27A is a SEM image of carbon nanostructures grown on a Ta substrate according to one example of the present invention;

FIG. 27B is a SEM image of carbon nanostructures grown on a Ta substrate according to one example of the present invention;

FIG. 27C is a SEM image of carbon nanostructures grown on a Ta substrate according to one example of the present invention;

FIG. 27D is a SEM image of carbon nanostructures grown on a Ta substrate according to one example of the present invention;

FIG. 28A is a SEM image of carbon nanostructures grown on a Cr substrate according to one example of the present invention;

FIG. 28B is a SEM image of carbon nanostructures grown on a Cr substrate according to one example of the present invention;

FIG. 28C is a SEM image of carbon nanostructures grown on a Cr substrate according to one example of the present invention;

FIG. 28D is a SEM image of carbon nanostructures grown on a Cr substrate according to one example of the present invention;

FIG. 29A is a SEM image of carbon nanostructures grown on a Mo substrate in accordance with an example of the present invention;

FIG. 29B is a SEM image of carbon nanostructures grown on a Mo substrate in accordance with an example of the present invention;

FIG. 29C is a SEM image of carbon nanostructures grown on a Mo substrate in accordance with an example of the present invention;

FIG. 29D is a SEM image of carbon nanostructures grown on a Mo substrate in accordance with an example of the present invention;

FIG. 30A is a SEM image of carbon nanostructures grown on a W substrate according to one example of the present invention;

FIG. 30B is a SEM image of carbon nanostructures grown on a W substrate according to one example of the present invention;

FIG. 30C is a SEM image of carbon nanostructures grown on a W substrate according to one example of the present invention;

FIG. 30D is a SEM image of carbon nanostructures grown on a W substrate according to one example of the present invention;

FIG. 31A is a SEM image of carbon nanostructures grown on a Pd substrate according to one example of the present invention;

FIG. 31B is a SEM image of carbon nanostructures grown on a Pd substrate according to one example of the present invention;

FIG. 31C is a SEM image of carbon nanostructures grown on a Pd substrate according to one example of the present invention;

FIG. 31D is a SEM image of carbon nanostructures grown on a Pd substrate according to one example of the present invention;

FIG. 32A is a SEM image of carbon nanostructures grown on a Pt substrate according to one example of the present invention;

FIG. 32B is a SEM image of carbon nanostructures grown on a Pt substrate according to one example of the present invention;

FIG. 32C is a SEM image of carbon nanostructures grown on a Pt substrate according to one example of the present invention;

FIG. 32D is a SEM image of carbon nanostructures grown on a Pt substrate according to one example of the present invention;

FIG. 33A is a SEM image of carbon nanostructures grown on a Cu substrate according to one example of the present invention

FIG. 33B is a SEM image of carbon nanostructures grown on a Cu substrate according to one example of the present invention

FIG. 33C is a SEM image of carbon nanostructures grown on a Cu substrate according to one example of the present invention

FIG. 33D is a SEM image of carbon nanostructures grown on a Cu substrate according to one example of the present invention

FIG. 34A is a SEM image of carbon nanostructures grown on a zircaloy substrate according to one example of the present invention;

FIG. 34B is a SEM image of carbon nanostructures grown on a zircaloy substrate according to one example of the present invention;

FIG. 34C is a SEM image of carbon nanostructures grown on a zircaloy substrate according to one example of the present invention;

FIG. 34D is a SEM image of carbon nanostructures grown on a zircaloy substrate according to one example of the present invention;

FIG. 35A is a SEM image of carbon nanostructures grown on a SUS304 substrate according to one example of the present invention;

FIG. 35B is a SEM image of carbon nanostructures grown on a SUS304 substrate according to one example of the present invention;

FIG. 35C is a SEM image of carbon nanostructures grown on a SUS304 substrate according to one example of the present invention;

FIG. 35D is a SEM image of carbon nanostructures grown on a SUS304 substrate according to one example of the present invention;

FIG. 36A is a SEM image of carbon nanostructures grown on an Au substrate according to one example of the present invention;

FIG. 36B is a SEM image of carbon nanostructures grown on an Au substrate according to one example of the present invention;

FIG. 36C is a SEM image of carbon nanostructures grown on an Au substrate according to one example of the present invention;

FIG. 36D is a SEM image of carbon nanostructures grown on an Au substrate according to one example of the present invention;

FIG. 37A is a SEM image of carbon nanostructures grown on an Ag substrate according to one example of the present invention;

FIG. 37B is a SEM image of carbon nanostructures grown on an Ag substrate according to one example of the present invention;

FIG. 37C is a SEM image of carbon nanostructures grown on an Ag substrate according to one example of the present invention;

FIG. 37D is a SEM image of carbon nanostructures grown on an Ag substrate according to one example of the present invention;

FIG. 38A is a SEM image of carbon nanostructures grown on an isotropic graphite substrate according to one example of the present invention;

FIG. 38B is a SEM image of carbon nanostructures grown on an isotropic graphite substrate according to one example of the present invention;

FIG. 38C is a SEM image of carbon nanostructures grown on an isotropic graphite substrate according to one example of the present invention;

FIG. 38D is a SEM image of carbon nanostructures grown on an isotropic graphite substrate according to one example of the present invention;

FIG. 39A is a SEM image of carbon nanostructures grown on a glassy carbon substrate according to one example of the present invention;

FIG. 39B is a SEM image of carbon nanostructures grown on a glassy carbon substrate according to one example of the present invention;

FIG. 39C is a SEM image of carbon nanostructures grown on a glassy carbon substrate according to one example of the present invention;

FIG. 39D is a SEM image of carbon nanostructures grown on a glassy carbon substrate according to one example of the present invention;

FIG. 40 is a diagram showing a Raman spectrum of carbon nanostructures grown on a zircaloy substrate and Ti substrate according to one example of the present invention;

FIG. 41A is a TEM image of carbon nanostructures grown on a Zr substrate according to one example of the present invention;

FIG. 41B is a TEM image of carbon nanostructures grown on a Zr substrate according to one example of the present invention;

FIG. 42A is a TEM image of carbon nanostructures grown on an Au substrate according to one example of the present invention;

FIG. 42B is a TEM image of carbon nanostructures grown on an Au substrate according to one example of the present invention;

FIG. 42C is a TEM image of carbon nanostructures grown on an Au substrate according to one example of the present invention;

FIG. 43A is a TEM image of carbon nanostructures grown on an isotropic graphite substrate according to one example of the present invention;

FIG. 43B is a TEM image of carbon nanostructures grown on an isotropic graphite substrate according to one example of the present invention;

FIG. 43C is a TEM image of carbon nanostructures grown on an isotropic graphite substrate according to one example of the present invention;

FIG. 44A is a TEM image of carbon nanostructures grown on a glassy carbon substrate according to one example of the present invention;

FIG. 44B is a TEM image of carbon nanostructures grown on a glassy carbon substrate according to one example of the present invention;

FIG. 44C is a TEM image of carbon nanostructures grown on a glassy carbon substrate according to one example of the present invention;

FIG. 45A is a diagram showing the spectral emissivity measurement results of carbon nanostructures grown on a Zr substrate according to one example of the present invention, and shows the spectral emissivity measurement results in the visible light range;

FIG. 45B is a diagram showing the spectral emissivity measurement results of carbon nanostructures grown on a Zr substrate according to one example of the present invention, and shows the spectral emissivity measurement results the infrared range;

FIG. 46A is a diagram showing the spectral emissivity measurement results of carbon nanostructures grown on a Ti substrate according to one example of the present invention, and shows the spectral emissivity measurement results in the visible light range;

FIG. 46B is a diagram showing the spectral emissivity measurement results of carbon nanostructures grown on a Ti substrate according to one example of the present invention, and shows the spectral emissivity measurement results the infrared range;

FIG. 47A is a diagram showing the spectral emissivity measurement results of carbon nanostructures grown on a zircaloy substrate according to one example of the present invention and shows the spectral emissivity measurement results in the visible light range; and

FIG. 47B is a diagram showing the spectral emissivity measurement results of carbon nanostructures grown on a zircaloy substrate according to one example of the present invention, and shows the spectral emissivity measurement results the infrared range.

### REFERENCE SIGNS LIST

100: optical member, 110: substrate, 115: rough surface, 120: inorganic layer, 121: inorganic fine particles, 130: catalyst metal particle layer, 131: catalyst metal particle, 150: carbon nanostructure, 200: optical member, 210: metal substrate, 215: rough surface, 220: inorganic layer, 221: inorganic layer, 223: oxide film, 230: catalyst metal particle layer, 231: catalyst metal particle

### DESCRIPTION OF EMBODIMENTS

As a results of the present inventors making an intensive investigation in order to solve the problems described above, a method was devised for uniformly forming a carbon nanostructure by a CVD method without using a reduction gas and without performing a surface treatment using a sputtering or vacuum evaporation method on a surface of a three-dimensional object comprised from a pure metal, an alloy that does not contain an iron-based transition metal or inorganic carbon, and established a method for cheaply and efficiently producing an optical member having a high emissivity.

An optical member and a producing method thereof related to the present invention are explained below with reference to the drawings. An optical member and a producing method thereof of the present invention are not to be construed as being limited to the description of the embodiments and examples shown below. Furthermore, in the drawings referred in the present embodiment and examples, the same parts or parts having similar functions are denoted by the same reference numerals, and repeated description thereof are omitted.

In the present specification, an optical member is a material or object having a function for radiating and absorbing electromagnetic waves. In addition, a material or object which has a function for radiating electromagnetic waves is sometimes referred to in particular as an electromagnetic wave radiator, and a material or object which has a function for absorbing electromagnetic waves is sometimes referred to in particular as an electromagnetic wave absorber. Here, electromagnetic waves have a wide wavelength including radio waves, infrared light, visible light, ultraviolet light and X-rays.

In order to uniformly grow a carbon nanostructure on a substrate surface by a CVD method using thermal decomposition of a hydrocarbon, it is necessary to form a thin film of a discontinuous structure of an inorganic material (hereinafter, referred to as a catalyst supporting layer) capable of carrying metal fine metal as a catalyst. As a result of the present inventors intensive examination, it was found that after selecting a metal which oxidizes easier than a catalyst metal as a material of a substrate to growing a carbon nanostructure on the surface of the material of the substrate, a thermal oxide film of a metal substrate surface which is generated when heating to a temperature (approximately 700° C. or higher) for performing thermal decomposition of a hydrocarbon without introducing a reduction gas such as hydrogen, can be used as a catalyst supporting layer. In particular, it was confirmed that a carbon nanostructure is uniformly grown without defects on the metal substrate surface in the case of growing a thermal oxide film after roughening a metal substrate surface.

A rough surface described here refers to a surface structure in which an infinite number of irregular bent parts having a varying curvature radius exist on the surface, and fine cracks occurs in the infinite number of bent parts of a film due to a thermal expansion difference between the thermal oxide film formed when heating and the metal substrate. Therefore, there are more spaces in the thermal oxide film formed on a rough surface as compared to a smooth surface. In addition, since a catalyst metal is firmly deposited in these spaces, it was found that the effect of uniformly growing a carbon nanostructure increases without defects on the substrate surface.

In addition, the present inventors have found it is possible to roughen a metal substrate surface by colliding inorganic fine particles in an aerodynamic or projection manner to a metal substrate (hereinafter, also referred to as a fine powder shot process.), and that it is also possible to form a catalyst supporting layer on a surface with respect to a metal which is not formed with a thermal oxide film under conditions where thermal decomposition of a hydrocarbon progresses, and completed the present invention. For example, an oxide of a noble metal such as platinum cannot thermodynamically exist under the condition that thermal decomposition of a hydrocarbon is carried out. In addition, an oxide of tungsten has a property of easily subliming at high temperatures. Therefore, it is not possible to produce a carbon nanostructure using a thermal oxide film of the metal substrate itself as a catalyst supporting layer with these metals as the substrate.

The present invention makes it possible for the first time to form a catalyst supporting layer by intruding countless inorganic particles into a surface layer of a metal substrate or an inorganic carbon substrate using a fine powder shot process, and growing a carbon nanostructure on a metal or inorganic carbon which is not formed with a thermal oxide film under the condition where thermal decomposition of hydrocarbons progresses. In addition, in the case of a metal substrate grown with a thermal oxide film under the condition where thermal decomposition of hydrocarbons progresses, since both a thermal oxide film of the metal substrate itself and a surface layer intruded with inorganic fine particles by a fine powder shot process function as a catalyst supporting layer, it is possible to obtain the effect of uniformly growing a carbon nanostructure on a surface without defects.

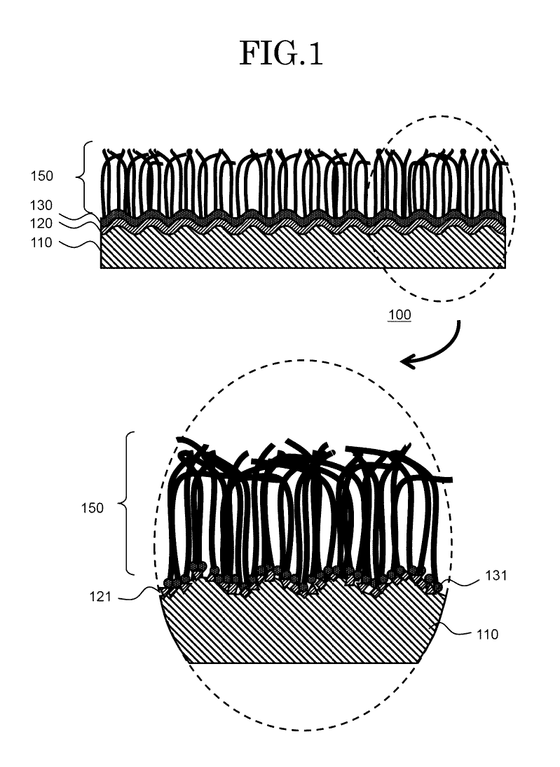

FIG. 1 is a schematic diagram showing an optical member 100 related to one embodiment of the present invention. The optical member 100 is arranged with, for example, a substrate 110 with at least a part having a rough surface, an inorganic layer 120 formed on the rough surface of the substrate 110, a catalyst metal particle layer 130 supported on the inorganic layer 120, and a carbon nanostructure 150 formed on the catalyst metal fine particle layer 130.

### [Carbon Nanostructure]

The carbon nanostructure 150 formed by the present invention is a fibrous material having a fine tubular structure comprised from a carbon film (graphene sheet) such as carbon nanotubes (CNT) or carbon nanofibers (CNF). Although the carbon nanostructure 150 formed by the present invention is mainly multi-walled carbon nanotube (MWCNT), the present invention is not limited to these. The carbon nanostructure 150 is grown from catalyst metal particles 131 which form the catalyst metal fine particle layer 130 oriented generally perpendicular to the surface of the substrate 110, and forms an aggregate having a tip which is non-oriented at the top part (surface layer or surface) of the carbon nanostructure 150. In Japanese Laid Open Patent Publication No. 2010-192581 described above, since single-walled carbon nanotubes are grown vertically aligned at a high density on an object, the surface forms a structure in which the tip of the carbon nanotubes are arranged regularly and at high density. There was concern that angular anisotropy of emissivity (absorptivity) becomes significant due to a light interference effect derived from such structural regularity. On the other hand, the carbon nanostructure 150 related to the present invention has thicker multi-wall carbon nanotubes than single-walled carbon nanotubes which are vertically aligned at a relatively low density. Therefore, since there is relative space around the carbon nanotube tip, the top part (surface layer or surface) forms a relatively non-oriented aggregate. Due to the irregularity of such structures, angular anisotropy of emissivity (absorption rate) is very small.

### [Substrate]

A material of the substrate 110 is a pure metal and alloy which do not melt at a growth temperature of a carbon nanostructure or an inorganic carbon, for example, a pure metal and allow or inorganic carbon which does not melt at the thermal decomposition temperature (about 750° C.) of acetylene which is a raw material of carbon nanotubes. When producing a CNT or CNF by a CVD method, although certain alloys which can be used as the material of the substrate for growing the CNT or CNF are described in Japanese Laid Open Patent Publication No. 2010-192581 and L. Randall et al., Carbon, 41, 659-672 (2003) and Talapatra et al., Nature Nanotechnology, 1, 112-116 (2006), generally a silicon substrate is used. The reason for this is that since the research and development for application of CNT to a member above an electronic device made from a silicon substrate has been actively carried out, the accumulation of techniques for growing a CNT on a silicon substrate is proceeding and easiness obtaining a stable, smooth high-purity substrate at a high temperature is also a reason.

However, using an object grown with a carbon nanostructure on a silicon substrate as the optical member is not always appropriate. Although an optical member generally requires a constant temperature distribution, since a silicon substrate which is a semiconductor has low thermal conductivity compared to metals, there is a fear that a temperature distribution in comparison with a metal substrate becomes uneven. Although an optical member used for the emission of electromagnetic waves is necessary for heating in order to emit the intended electromagnetic waves, in the case of a metal substrate, temperature can be easily controlled by electrical heating. In addition, in the case of producing an optical member having a complicated shape, use of a metal or an inorganic carbon material rather than silicon makes processing easier. For these reasons, a substrate which forms an optical member is desired to be a metal or inorganic carbon.

In order to grow a carbon nanostructure on a metal or inorganic carbon by thermal decomposition of hydrocarbons, it is necessary to adhere catalytic metal particles on an inorganic layer after forming the inorganic material layer having an infinite number of small spaces on the metal substrate surface. In the present invention, by forming the inorganic layer 120 and the catalyst metal particle layer 130 by a method described in detail below, the carbon nanostructure 150 can be formed on the surface of a metal substrate or inorganic carbon substrate of almost any material. The substrate 110 is not limited to a flat substrate, and as long as the substrate has a surface that can be a roughened in order to form the inorganic material layer 120, a three-dimensional structure is also possible. In the present invention, a rough surface to be formed on the surface of the substrate 110 provides a place suitable for the growth of a carbon nanostructure 150.

In the present invention, as described later, in the case where the material of the substrate 110 is a metal, a metal which oxidizes easier than a catalyst metal is possible. The substrate 110 has a rough surface in a region for forming at least the catalyst metal particle layer 130. When a metal is used for such a substrate, when the substrate itself plays a role of a reducing agent that retains the activity of a catalyst metal, a function of an oxide film of the substrate itself to support the catalyst metal fine particles is also exhibited. Therefore, when using a metal substrate which oxidizes easier than a catalyst metal, because the inorganic material layer 120 has an enhanced effect of supporting catalyst metal fine particles due to the presence of an oxide film on the substrate itself, it is possible to obtain the effect of suppressing the occurrence of defects on the substrate of a carbon nanostructure. In the present invention, it was actually confirmed that it is possible to obtain a carbon nanostructure grown uniformly without defects with respect to the substrate 110 comprised from a metal selected from the group comprising of Ti, Zr, Hf, V, Nb, Ta, and Cr which are regarded as metals in which massive members can be obtained relatively easy or an alloy containing these metals as a main component among metals which oxidizes easier than iron which is a typical catalyst metal. As an alloy which can be used as the substrate 110, for example, zircaloy or the like with Zr as a main component is available.

In the present invention, as described later, the material of the substrate 110 can be a metal or inorganic carbon which is more difficult to oxidize than a catalyst metal. The substrate 110 has a rough surface in a region for forming at least the catalyst metal particle layer 130. In the case of a metal or inorganic carbon, an oxide film is not formed on the substrate itself. For example, as a metal which has a high equilibrium oxygen partial pressure of an oxide formation reaction compared to three kinds of oxide (FeO, Fe₂O₃ and Fe₃O₄) of iron used as the catalyst metal, metals selected from the group consisting of Cu, Ag, Au, Pt, Pd, Rh, Ir, Re, Mo or an alloy containing these as a main component can be given as examples. In the case of W or an alloy containing W as a main component, since the equilibrium oxygen partial pressure of WO₃, which is a representative oxide of W, is greater than FeO and Fe₃O₄ but less than Fe₂O₃, it is likely that W03 is formed on the surface. However, WO₃ has a property of easy sublimation at a high temperature. In addition, since carbon dioxide and carbon monoxide which are oxides of inorganic carbon, are present as a gas at the thermal decomposition temperature of a hydrocarbon, they are never adhered to the substrate surface as a film of a solid phase. Therefore, although it was thought that it is difficult to form a sufficient thermal oxide film, that is, a catalyst supporting layer by a combination of 9 types of substance such as Cu, Pt, Pd, Mo, W, Au, Ag, isotropic graphite a glassy carbon, which are parts of a substrate which we tried to produce a film of a carbon nanostructure and iron catalyst, we actually confirmed that it is possible to grow a carbon nanostructure using the substrate according to the present invention.

### [Inorganic Layer]

The inorganic layer 120 is a scaffold for supporting the catalyst metal fine particles 131 for forming the catalytic metal particle layer 130. Inorganic fine particles 121 are comprised from a metal oxide, a metal nitride or metal carbide which is hard inorganic materials. Although it is possible to use a metal oxide, preferably alumina, zirconia, titania, and hafnia for example as the inorganic fine particles 121, the present invention is not limited to these. In the prior art, an inorganic layer used for supporting a catalyst is formed by a sputtering method above a substrate or a method of forming an oxide film by performing an oxidation treatment after depositing a metal thin film by a vacuum deposition device was used. On the other hand, in the present invention, the inorganic layer 120 is a film having a discontinuous structure in which inorganic fine particles 121 are irregularly distributed. Such an inorganic layer 120 can be formed, for example, by implementing a process (fine powder shot process) of colliding a fine powder of a hard inorganic material such as the metal oxides described above on a surface of the substrate 110 by an aerodynamic or projection method.

Since a part of the inorganic fine particles 121 which have been collide into the surface of the substrate 110, are finely broken and cut into the surface of the substrate 110 in countless numbers, it is possible for those inorganic fine particles 121 to support the catalyst metal particles 131. In addition, the since the surface of the substrate 110 becomes rough by the fine powder shot process, a thermal oxide film on the surface of the substrate 110 which is produced during heating for performing thermal decomposition of hydrocarbons, becomes a discontinuous structure having an infinite number of small spaces. The catalytic metal particles 131 can be uniformly deposited without defects in a substrate surface by the presence of these two types of catalyst supporting carrying medium. In addition, since contaminants which are present in the surface of the substrate 110 are mechanically scraped off due to the fine powder shot process, it is possible to obtain the effect of cleaning the surface of the substrate 110. In addition, since during the fine powder shot process it is not necessary to process by installing a substrate in a vacuum chamber or the like and it is easy to change the direction of which the fine powder is injected during processing, it is possible to perform processing on the entire surface of the substrate regardless of the shape and size of the substrate.

For example, in the case of forming the inorganic layer 120 by a fine powder shot process using fine alumina powder, even in the case where a definite inorganic layer 120 is not observed in a scanning electron microscope (hereinafter, also referred to as SEM) image, a peak corresponding to Al at a position of about 1390 eV in an Auger spectrum of the outermost surface of the substrate 110 is detected.

In addition, in the case of using a metal substrate, an inorganic layer may also include an oxide film of the metal substrate itself formed in the substrate. In the case of using a metal substrate which oxidizes easier than a catalyst metal, an inorganic layer has an enhanced effect for supporting catalyst metal fine particles by the presence of an oxide film on the substrate itself.

### [Catalyst Metal Particle Layer]

The catalyst metal particle layer 130 is a catalyst layer for forming the carbon nanostructure 150 by thermally decomposing a hydrocarbon in a reaction system. The catalyst metal particle layer 130 is formed by the catalyst metal particles 131 supported on the inorganic layer 120. The catalyst metal particles 131 are formed by, for example, a vapor flow method in which a metal complex such as ferrocene or carbonyl iron containing iron which can be a catalyst for the thermal decomposition of the hydrocarbon in the reaction system is used for the catalyst precursor. In addition, it also appears possible to use cobaltocene which is a metal complex containing Co as a catalyst precursor. However, in the case where a vapor flow method is used as the method of supplying the catalyst metal particles 131, it is possible to suitably use ferrocene from the viewpoint of safety and handling. In the case of a vapor flow method, it is possible to form a catalyst layer on the entire surface of a three-dimensional shaped object due to diffusing catalyst metal fine particles throughout a reaction furnace and it is also possible to effectively form a catalyst layer using the same reactor furnace immediately prior to the thermal decomposition reaction of the hydrocarbon.

Conventionally, although a sputtering device used for forming a catalyst supporting layer and catalyst layer can generally form a catalyst supporting layer and catalyst layer as long as the substrate is on a flat plate, forming a catalyst supporting layer and catalyst layer on the surface of a substrate having a three-dimensional shape so that an obstruction exists between the sputtering target or vapor deposition source and the substrate is difficult. On the other hand, in the present invention, by combining the formation of the inorganic layer 120 by a fine powder shot process and the formation of the catalyst metal particle layer 130 by a vapor flow method, the carbon nanostructure 150 can be grown on the surface of a substrate having a three-dimensional shape.

### [Characteristics of the Optical Member]

Spectral emissivity in the visible wavelength region of the optical member related to the present invention is 0.99 or more, and spectral emissivity of in the infrared wavelength region is 0.98 or more.

In addition, when a Raman spectroscopic analysis is performed on the optical member related to the present invention, a peak derived from graphite in the vicinity of 1590 cm⁻¹ (G-band) is detected, and a peak derived from defects in the vicinity of 1350 cm⁻¹ (D-band) is detected. On the other hand, in the optical member related to the present invention, since the carbon nanostructure 150 is mainly MWCNT, a distinctive peak of 300 cm⁻¹ or less (Radial Breathing Mode: RBM) in a single-layer CNT is not detected.

### [Method for Producing an Optical Member]

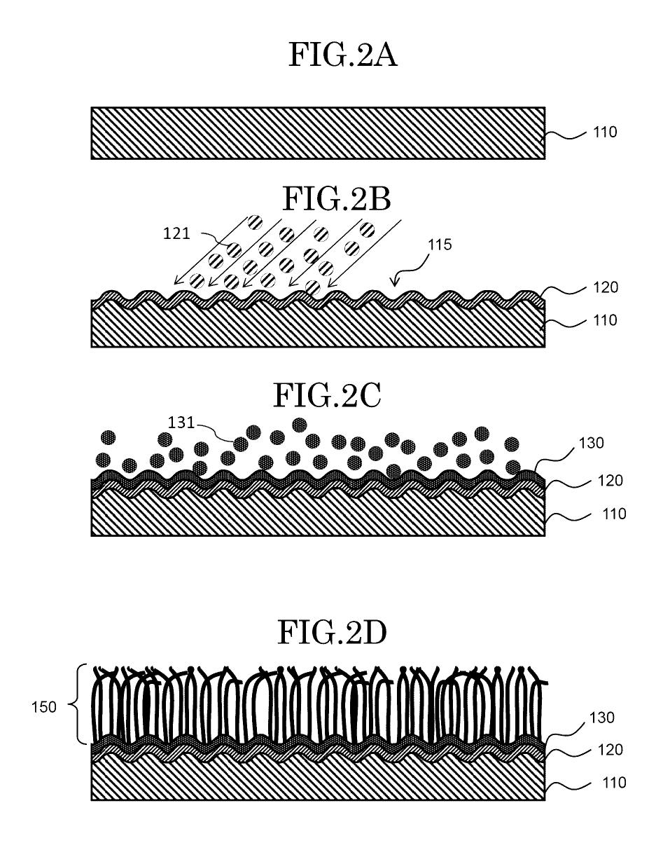

A method for producing the optical member related to the present invention is explained. FIGS. 2A to 2D schematic diagrams showing a method for producing an optical member 100 related to one embodiment of the present invention. Substrate 110 is prepared (FIG. 2A). Substrate 110 is also formed from a metal or inorganic carbon that does not melt at the thermal decomposition temperature of a hydrocarbon which serves a raw material for a carbon nanostructure, and as long as they have a surface which can roughened, the material and shape are not particularly limited.

A rough surface 115 is formed on at least a part of the substrate 110, and the inorganic layer 120 is formed on the rough surface 115 of the substrate 110 (FIG. 2B). The rough surface 115 of the substrate 110 can be formed by colliding the inorganic fine particles 121 at the substrate 110 by an aerodynamic or projection method (fine powder shot process). The Inorganic fine particles 121 are comprised from a metal oxide, metal nitride or metal carbide, and are predominantly alumina fine powders having a particle size of about 10 to 40 μm for example. It is possible to use a commercially available air blasting device in the fine powder shot process.

Since a part of the inorganic fine particles 121 which collide to form a rough surface 115 on the substrate 110 are finely broken and bite into the surface of the substrate 110 in countless numbers, it is possible for these inorganic fine particles 121 to support the catalyst metal particles 131. In addition, since contaminants present on the surface of the substrate 110 process are mechanically scraped off due to the fine powder shot, the effect of cleaning the surface of the substrate 110 is also obtained.

The catalyst metal fine particle layer 130 is formed on the inorganic layer 120 (FIG. 2C). The catalyst metal particle layer 130 is formed by supplying a vapor containing catalytic metal particles 131 which are generated by heating a metal complex. For example, substrate 110 formed with an inorganic layer 120 and a powder of a metal complex of a catalyst precursor are installed in a CVD reactor for growing a carbon nanostructure 150, and the inside of the furnace is heated to a temperature until the metal complex evaporates under a nitrogen gas atmosphere. Floating catalyst metal particles 131 are deposited on the inorganic layer 120 to form the catalyst metal particle layer 130. At this time, in the present invention, since the inorganic layer 120 has a discontinuous structure formed by the inorganic fine particles 121, the catalyst metal particles 131 also form the catalyst metal fine particle layer 130 having a discontinuous structure.

Hydrocarbons are supplied to the substrate 110 formed with the catalyst metal fine particle layer 130, and the carbon nanostructure 150 is formed on the catalytic metal particle layer 130 (FIG. 2D). It is possible to use a known material for forming a carbon nanostructure 150 as the hydrocarbons to be supplied, for example, acetylene can be preferably used. In the case where acetylene is supplied to grow the carbon nanostructure 150, either acetylene is introduced into the furnace after heating the inside of the furnace to about 750° C., which is the thermal decomposition temperature of acetylene, or the furnace may be heated up about 750° C. after the acetylene introduced. The furnace temperature can be set arbitrarily based on the thermal decomposition temperature of the hydrocarbon to be used. In this way, it is possible to produce the optical member 100 related to the present invention.

Furthermore, the substrate 110 formed with the inorganic layer 120 and the powder of the metal complex of the catalyst precursor are set in the CVD reactor, nitrogen gas and acetylene are supplied and the furnace is heating to 750° C., the metal complex is sublimated at a preheating phase (100° C. to 200° C. in the case of using ferrocene as the metal complex), the catalyst metal particles 131 are deposited on the inorganic layer 120 to form a catalyst metal particle layer 130, and it is possible to grown a carbon nanostructure 150 at the point where the furnace temperature reaches about 750° C.

In addition, in order to produce the optical member related to the present invention, it is also possible to use a metal substrate comprised from a metal which oxidizes more easily than a catalyst metal. A method for producing an optical member 200 using a metal substrate comprised from a metal which oxidizes more easily than a catalyst metal is explained below.

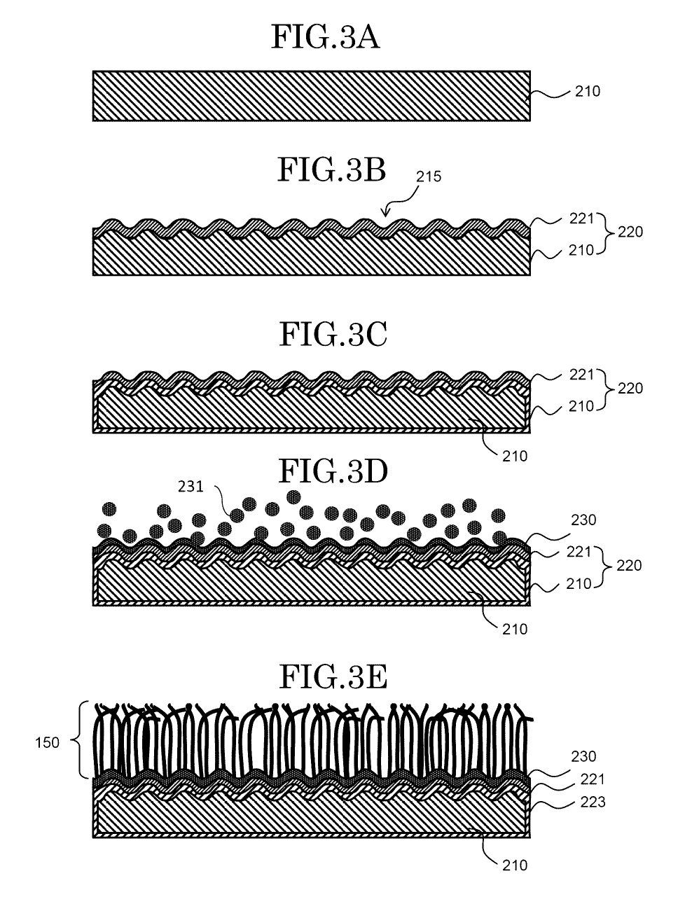

The metal substrate 210 comprised from a metal which oxidizes more easily than a catalyst is prepared (FIG. 3A). Here, the material of the metal substrate 210 can be selected in consideration of the catalytic metal to be used in the catalyst metal fine particle layer 230, and in the case where iron is selected as the catalyst metal, a metal selected from a group comprising of Ti, Zr, Hf, V, Nb, Ta and Cr and an alloy with these metals as the main component may be selected.

A rough surface 215 is formed on at least a part of the metal substrate 210, and the inorganic layer 221 is formed on the rough surface 215 of the metal substrate 210 (FIG. 3B). By turning the surface of the metal substrate 210 into the rough surface 215, the effect of increasing the number of small spaces in a thermal oxide film generated on the surface of the metal substrate 210 at the time of heating for carrying out thermal decomposition of hydrocarbons is also obtained.

The metal substrate 210 formed with inorganic layer 221 is arranged in the CVD reaction furnace, the reaction furnace is heated, the metal substrate 210 is oxidized, and an oxide film 223 is formed on the surface of the metal substrate 210 (FIG. 3C). In the present embodiment, two types of medium of the inorganic layer 221 and the oxide film 223 form the inorganic layer 220. Due to the presence of these two types of catalyst supporting medium, it is possible to uniformly deposit the catalyst metal particles 131 on the substrate surface without defects. However, in the case where the medium contributing to the support of the catalytic metal particle layer 230 in the present embodiment is mainly an oxide film 223, a fine powder shot process may be omitted in the case where the occurrence of defects in the carbon nanostructure are permitted.

The catalyst metal fine particle layer 230 is formed on the inorganic layer 220 (FIG. 3D). Since the method of forming the catalyst metal particle layer 230 is described above, a detailed description will be omitted.

In the present embodiment, it is possible to grow the carbon nanostructure 150 without introducing a reducing agent into a CVD reactor. Conventionally, when producing a carbon nanostructure using a CVD method, hydrogen or carbon monoxide is introduced to maintain catalyst activity by preventing the oxidation of a catalyst metal. In the present embodiment, by selecting a metal which oxidizes more easily than a catalyst metals as the metal substrate 210 for growing the carbon nanostructure 150, as long as the metal substrate 210 is amply present in reaction furnace, the oxygen partial pressure within the CVD reaction furnace is maintained at a lower state than the equilibrium oxygen partial pressure at which generation of an oxide of the catalyst metal is initiated. As a result, activity of the catalyst metal particles 231 can be maintained while avoiding oxidation without introducing a reducing gas.

In the case where a reducing agent is not introduced, although an oxide film 223 is formed on the surface of the metal substrate 210 before reaching the CVD reaction temperature, the oxide film 223 can be utilized as a catalyst supporting layer. That is, by comparing the equilibrium oxygen partial pressure of each oxide of the catalyst metal and the metal substrate 210 and suitably combining, an oxide film 223 which acts as a catalyst support on the surface of the metal substrate 210 in the preheating stage before starting CVD is grown, it is possible to use the metal substrate 210 at the time of the CVD reaction as a reducing agent to maintain the activity of the catalyst metal, and it is possible to greatly simplify the producing process of the carbon nanostructure 150.

Furthermore, after forming the inorganic layer 220 in the CVD reaction furnace, a powder of a metal complex of the catalyst precursor is placed in a furnace, nitrogen gas and acetylene are supplied, the furnace is heated to 750° C., the metal complex is sublimated in a preheating phase (100° C. to 200° C. in the case of using ferrocene as the metal complex), the catalyst metal particles 231 are deposited on the inorganic layer 120 to form the catalyst metal particle layer 230, and the carbon nanostructure 150 can be grown at the point where the furnace temperature reaches about 750° C.

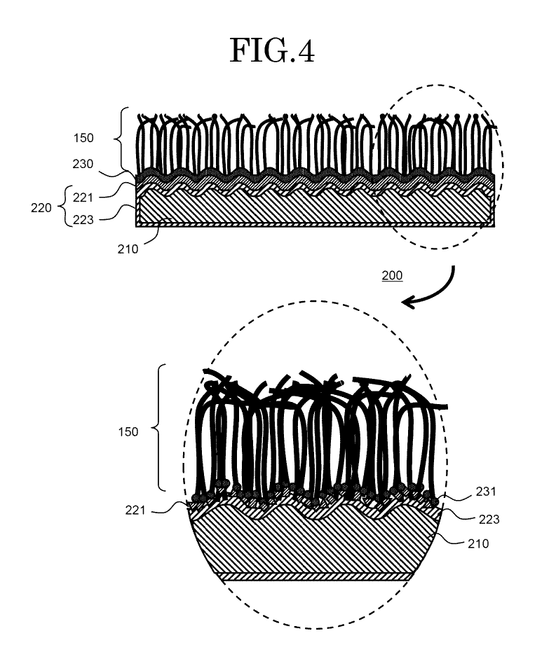

FIG. 4 shows a schematic view of an optical member 200 related to one embodiment of the present invention. As described above, the optical member 200, for example, is arranged with a metal substrate 210 having a rough surface on at least a part, an oxide film 223 of the metal substrate itself formed on the surface of the metal substrate 210, a catalyst metal particle layer 230 which is supported on an inorganic layer 220 comprising an inorganic layer 221 including inorganic fine particles formed on the rough surface of the metal substrate 210, and a carbon nanostructure 150 formed on the catalyst metal fine particle layer 230.

As described above, the producing method for the optical member related to the present invention is not restricted as compared to the prior art with respect to the material and shape of an object for forming a carbon nanostructure, and it is possible to uniformly grow the carbon nanostructure without defects on the surface of a three-dimensional object. In addition, it is possible to grow a carbon nanostructure using only a single CVD process omitting the film formation process of a catalyst supporting layer and catalyst metal layer by sputtering.

Further, in one embodiment, since it is not necessary to use hydrogen or carbon monoxide as a reducing agent which was required in the production of a of carbon nanostructure according to a conventional CVD method, there is the advantage of avoiding hydrogen embrittlement of a metal or the use of carbon monoxide which is a toxic gas which become problems when heating the metal in a hydrogen atmosphere. In particular, since it is possible to maintain partial pressure of hydrogen or water which is a by-product upon formation of the carbon nanostructure within a reaction furnace at a low value by not using hydrogen, it is possible to thermodynamically promote a hydrocarbon decomposition reaction. Furthermore, considering a spectral emissivity of 0.99 or more in the visible wavelength range, spectral emissivity of 0.98 or more in the infrared wavelength region, and an effective emissivity of a commercial plane blackbody furnace of at most 0.95, the optical member related to the present invention is an optical member of unprecedented high performance.

### EXAMPLES

The optical member related to the present invention is further explained using specific examples.

Acetylene was used as a raw material hydrocarbon gas using ferrocene as a catalyst precursor for a carbon nanostructure. As the substrate, a rectangular (40×4 mm) or disk shaped (φ43 to 45) substrate was cut from a substrate having a thickness of 0.2 to 1 mm comprised from 16 types of metals (Ti, Zr, Hf, V, Nb, Ta, Cr, Mo, W, Pd, Pt, Cu, zircaloy, SUS 304, Au and Ag) having a melting point higher than the thermal decomposition temperature of acetylene (about 750° C.), and two types of inorganic carbon (isotropic graphite, glassy carbon) using an electric discharge machine or milling machine. In the present invention, there is no particular limitation to the means for cutting the substrate.

As the inorganic fine particles, alumina powder with a particle number of #60 was loaded into an air blasting device (Fuji Manufacturing Co., Ltd, pneumatic blaster, model number SGF-4 (B)) and a fine powder shot process was carried out on the entire surface of the substrate. The air blasting device which is used ejects 0.9 MP high-pressure air at about 0.55 m³ per minute using a compressor and the alumina powder was sprayed on the surface of the substrate at a rate of about 140 m/s to form a rough surface.

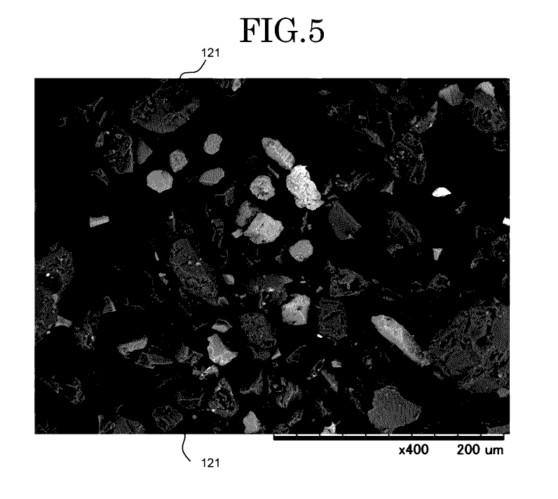

An electron microscope (SEM) image of the inorganic fine particles (alumina powder) used is shown in FIG. 5. As can be seen from a comparison of the scale and particle image in FIG. 5, the particle diameter of the inorganic fine particles was predominantly about 10 to 40 μm.

Among the 16 types of metal substrate described above, with regards to W which is considered to be the most hard and difficult to secure adhere alumina powder to the substrate, an Auger electron spectroscopy (AES) analysis was performed in order to determine whether the alumina powder is dispersed and adhered to a surface after performing the fine powder shot process. In addition, as a comparative example, AES was also performed with regard to tungsten which is not subjected to a fine powder shot process. Furthermore, before performing AES on both samples, ultrasonic cleaning was performed for 30 minutes or more on each sample using acetone, ethanol, and pure water in this order.

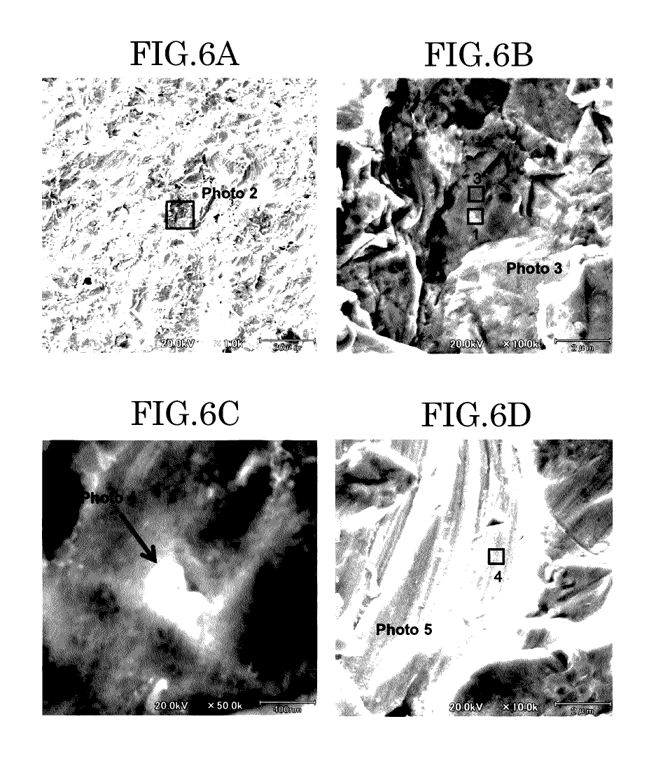

FIGS. 6A to 6D are two-dimensional electron image photographs including measurement points of the AES. The image with an enlarged part of the square frame in Photo 2 in FIG. 6A is the Photo 3 in FIG. 6B. AES was performed with respect to the two regions 1 and 3 enclosed by the square frame in Photo 3. In addition, the image with the enlarged region 1 is FIG. 6C (Photo 4), and AES was performed with respect to the outermost surface around the projection visible at the center. The region 3 in Photo 3 and the region 4 enclosed by the square frame in FIG. 6D (Photo 5) taken at different locations of the same sample are both smooth regions where protrusions are invisible, and AES was performed with respect to the outermost surface of these two regions.

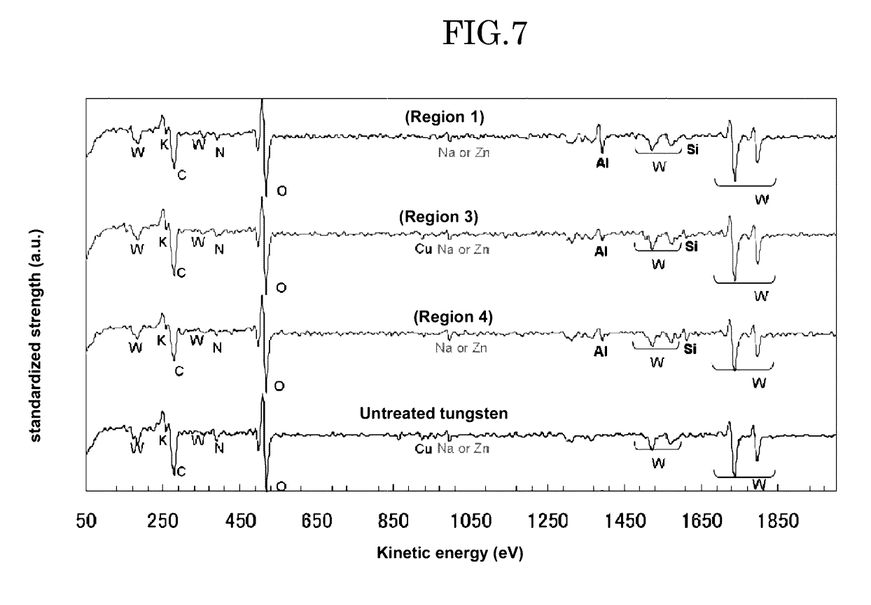

An Auger spectrum of the outermost surface of the regions 1, 3, 4 and untreated tungsten samples of Comparative Example are shown in FIG. 7. Peaks corresponding to Al which are present at the position of about 1390 eV in the spectrum of the regions 1, 3 and 4 were clearly detected. On the other hand, peaks corresponding to Al with respect to non-treated tungsten were not detected. When the size of a peak corresponding to Al of the region 1 and regions 3 and 4 were compared, the region 1 was larger. Therefore, a projection visible in region 1 is considered to be alumina particles having a diameter of about 200 nm, and it is considered that in the regions 3 and 4, considerably smaller alumina particles than these particles are dispersed in countless numbers. It was clear from these results that it is possible to adhere an infinite number of nanometer sized alumina fine particles to a metal substrate surface by a fine powder shot process using the alumina powder even with regards to hard tungsten.

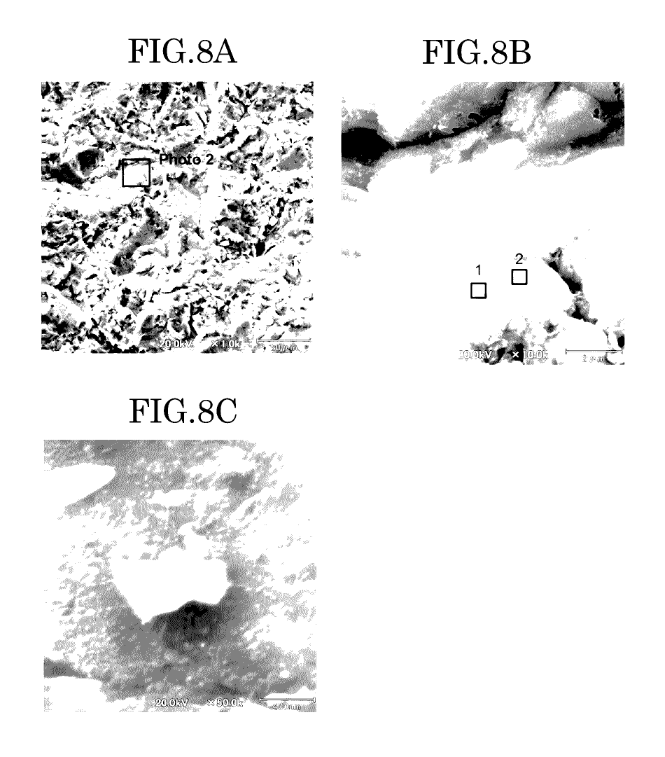

Similarly, AES was performed with respect to a Ti, Cr, Cu, Zr and Pt substrate subjected to fine powder shot process by fine alumina powder. FIGS. 8A to 8C are two-dimensional electron image photographs of a Ti substrate surface including the measurement points of AES. The image with an enlarged part of the square frame of Photo 2 in FIG. 8A is FIG. 8B. AES was performed with respect to the regions 1 and 2 enclosed by the square frame in FIG. 8B. In addition, the image with an enlarged region 1 is FIG. 8C, and AES was performed with respect to the outermost surface around the projection visible at the center. The region 2 in FIG. 8B is a smooth region in which protrusions are not visible.

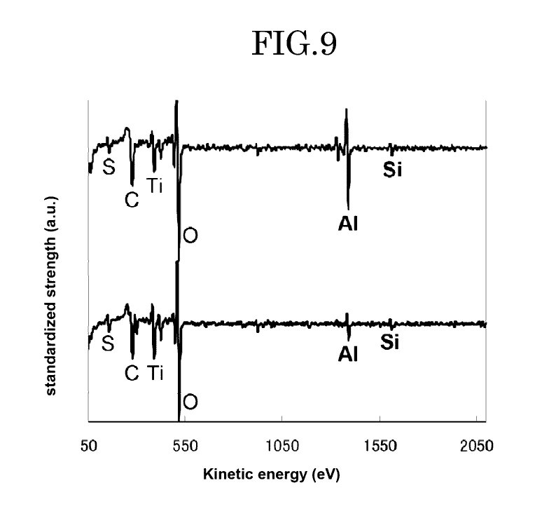

An Auger spectrum of the outermost surface of the regions 1 and 2 are shown in FIG. 9. Furthermore, in FIG. 9, the upper part shows the Auger spectrum of the outermost surface of the region 1, and the lower part shows the Auger spectrum of the outermost surface of the region 2. Peaks corresponding to Al at a position of about 1390 eV were clearly detected in the spectrum of region 1 and 2. When the size of the peaks corresponding to Al of region 1 and region 2 were compared, the region 1 was larger. Therefore, a projection visible in region 1 is considered to be alumina particles having a diameter of about 400 nm, and in the region 2 an infinite number of smaller alumina particles than these particles are dispersed. From these results it was clear that it is possible to adhere and infinite number of nanometer sized alumina fine particles to a metal substrate surface by a fine powder shot process using the alumina powder even with regards to Ti.

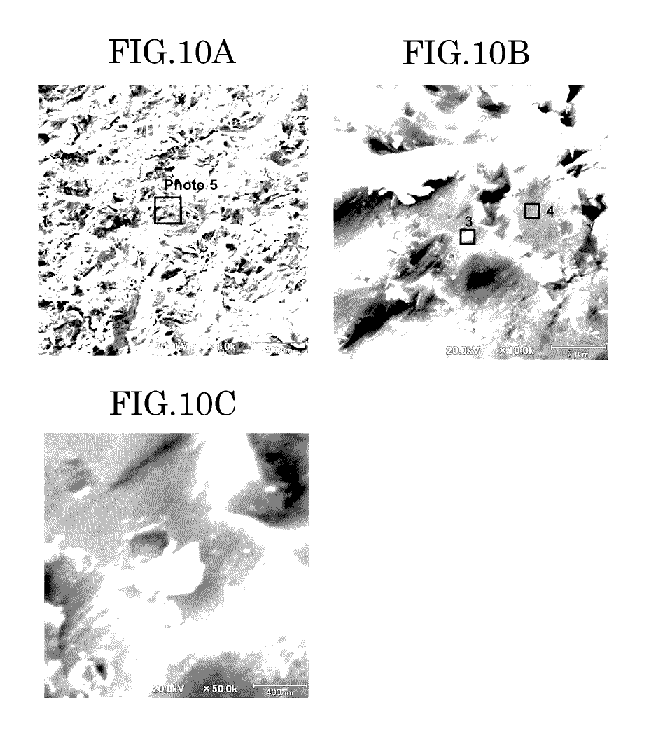

FIGS. 10A to 10C are two-dimensional electron image photographs of a Or substrate surface including the measurement points of AES. The image with an enlarged part of the square frame of Photo 5 in FIG. 10A is FIG. 10B. AES was performed with respect to the regions 3 and 4 enclosed by the square frame in FIG. 10B. In addition, the image with an enlarged region 3 is FIG. 10C, and AES was performed with respect to the outermost surface around the projection visible at the center. The region 4 in FIG. 10B is a smooth region in which protrusions are not visible.

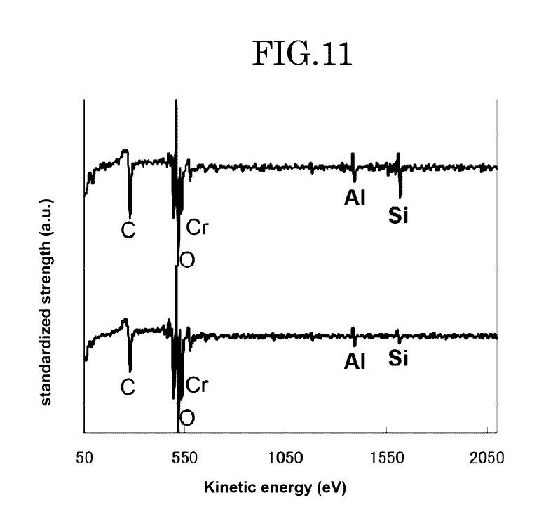

An Auger spectrum of the outermost surface of the regions 3 and 4 are shown in FIG. 11. Furthermore, in FIG. 11, the upper part shows the Auger spectrum of the outermost surface of the region 3, and the lower part shows the Auger spectrum of the outermost surface of the region 4. Peaks corresponding to Al at a position of about 1390 eV were clearly detected in the spectrum of region 3 and 4. When the size of the peaks corresponding to Al of region 3 and region 4 were compared, the region 3 was larger. Therefore, a projection visible in region 3 is considered to be alumina particles having a diameter of about 400 nm, and in the region 4 an infinite number of smaller alumina particles than these particles are dispersed. From these results it was clear that it is possible to adhere and infinite number of nanometer sized alumina fine particles to a metal substrate surface by a fine powder shot process using the alumina powder even with regards to Cr.

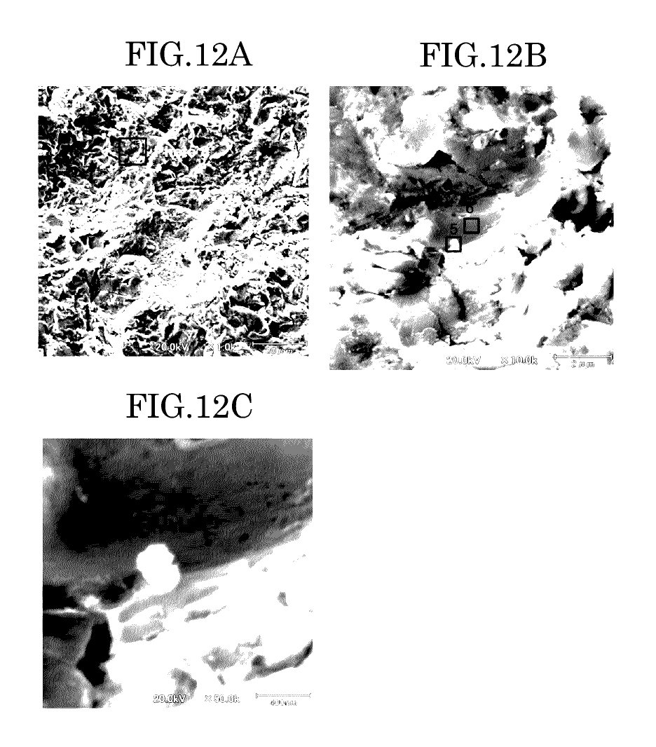

FIGS. 12A to 12C are two-dimensional electron image photographs of a Cu substrate surface including the measurement points of AES. The image with an enlarged part of the square frame of Photo 8 in FIG. 12A is FIG. 12B. AES was performed with respect to the regions 5 and 6 enclosed by the square frame in FIG. 12B. In addition, the image with an enlarged region 5 is FIG. 12C, and AES was performed with respect to the outermost surface around the projection visible at the center. The region 6 in FIG. 12B is a smooth region in which protrusions are not visible.

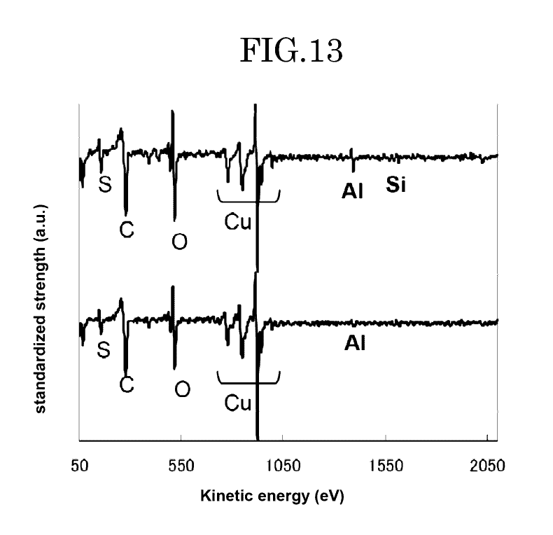

An Auger spectrum of the outermost surface of the regions 5 and 6 are shown in FIG. 13. Furthermore, in FIG. 13, the upper part shows the Auger spectrum of the outermost surface of the region 5, and the lower part shows the Auger spectrum of the outermost surface of the region 6. Peaks corresponding to Al at a position of about 1390 eV were clearly detected in the spectrum of region 5 and 6. When the size of the peaks corresponding to Al of region 5 and region 6 were compared, the region 5 was larger. Therefore, a projection visible in region 5 is considered to be alumina particles having a diameter of about 400 nm, and in the region 6 an infinite number of smaller alumina particles than these particles are dispersed. From these results it was clear that it is possible to adhere and infinite number of nanometer sized alumina fine particles to a metal substrate surface by a fine powder shot process using the alumina powder even with regards to Cu.

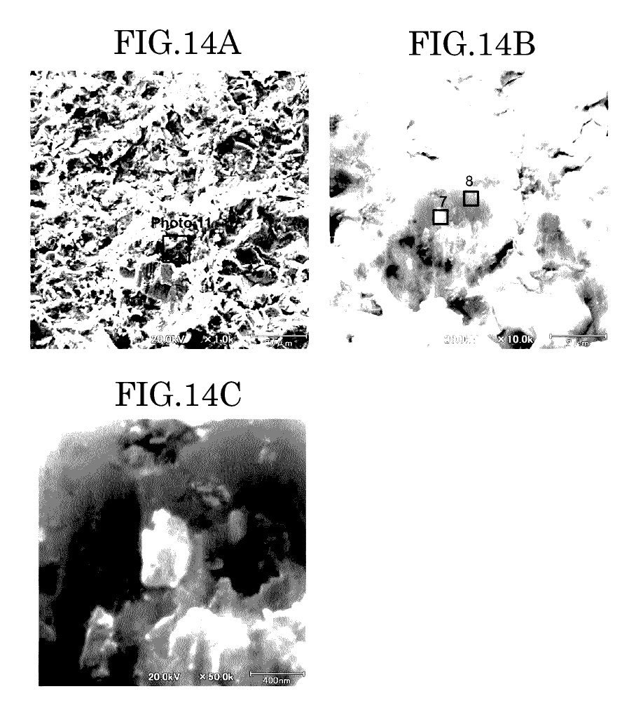

FIGS. 14A to 14C are two-dimensional electron image photographs of a Zr substrate surface including the measurement points of AES. The image with an enlarged part of the square frame of Photo 11 in FIG. 14A is FIG. 14B. AES was performed with respect to the regions 7 and 8 enclosed by the square frame in FIG. 14B. In addition, the image with an enlarged region 7 is FIG. 14C, and AES was performed with respect to the outermost surface around the projection visible at the center. The region 8 in FIG. 14B is a smooth region in which protrusions are not visible.

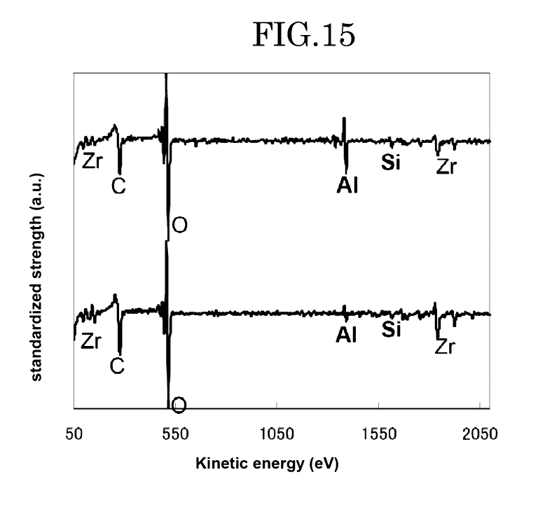

An Auger spectrum of the outermost surface of the regions 7 and 8 are shown in FIG. 15. Furthermore, in FIG. 15, the upper part shows the Auger spectrum of the outermost surface of the region 7, and the lower part shows the Auger spectrum of the outermost surface of the region 8. Peaks corresponding to Al at a position of about 1390 eV were clearly detected in the spectrum of region 7 and 8. When the size of the peaks corresponding to Al of region 8 and region 8 were compared, the region 7 was larger. Therefore, a projection visible in region 7 is considered to be alumina particles having a diameter of about 400 nm, and in the region 8 an infinite number of smaller alumina particles than these particles are dispersed. From these results it was clear that it is possible to adhere and infinite number of nanometer sized alumina fine particles to a metal substrate surface by a fine powder shot process using the alumina powder even with regards to Zr.

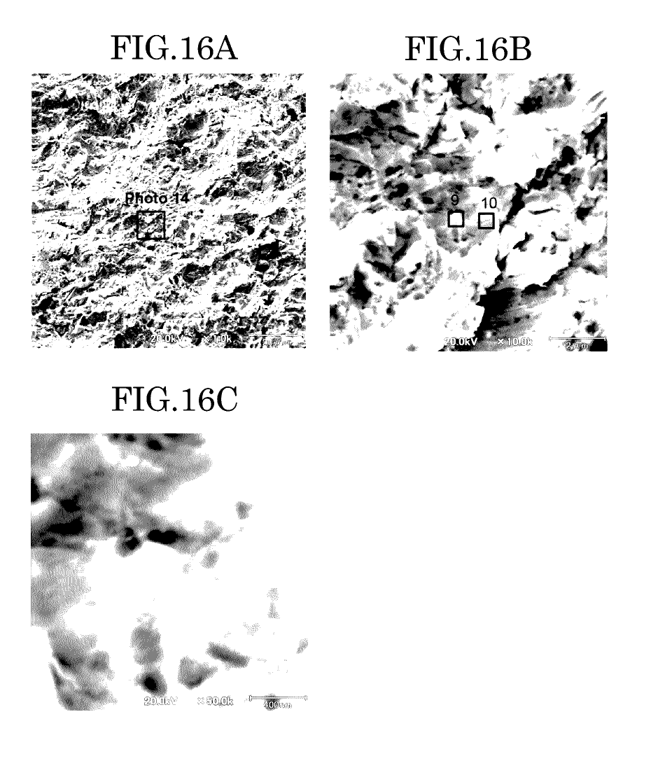

FIGS. 16A to 16C are two-dimensional electron image photographs of a Pt substrate surface including the measurement points of AES. The image with an enlarged part of the square frame of Photo 14 in FIG. 16A is FIG. 16B. AES was performed with respect to the regions 9 and 10 enclosed by the square frame in FIG. 16B. In addition, the image with an enlarged region 9 is FIG. 16C, and AES was performed with respect to the outermost surface around the projection visible at the center. The region 10 in FIG. 16B is a smooth region in which protrusions are not visible.

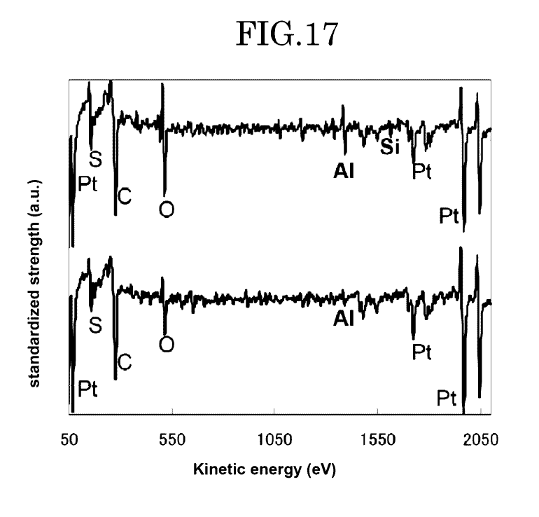

An Auger spectrum of the outermost surface of the regions 9 and 10 are shown in FIG. 17. Furthermore, in FIG. 17, the upper part shows the Auger spectrum of the outermost surface of the region 9, and the lower part shows the Auger spectrum of the outermost surface of the region 10. Peaks corresponding to Al at a position of about 1390 eV were clearly detected in the spectrum of region 9 and 10. When the size of the peaks corresponding to Al of region 9 and region 10 were compared, the region 9 was larger. Therefore, a projection visible in region 9 is considered to be alumina particles having a diameter of about 400 nm, and in the region 10 an infinite number of smaller alumina particles than these particles are dispersed. From these results it was clear that it is possible to adhere and infinite number of nanometer sized alumina fine particles to a metal substrate surface by a fine powder shot process using the alumina powder even with regards to Pt.

### [Al Surface Distribution of the Outermost Surface of a Substrate]

A surface analysis of aluminum (Al) in the outermost surface of a substrate subjected to a fine powder shot process using alumina powder was performed using a scanning Auger electron spectroscopic analyzer (ULVAC-PHI Inc. PHI-710). The measurement was at an acceleration voltage of 20 kV, and a current of 1 nA. An Auger electron spatial resolution was about 8 nm, surface distribution spatial resolution was 128×128 pixel (about 4 nm/step), and the measurement magnification was 200,000 times.

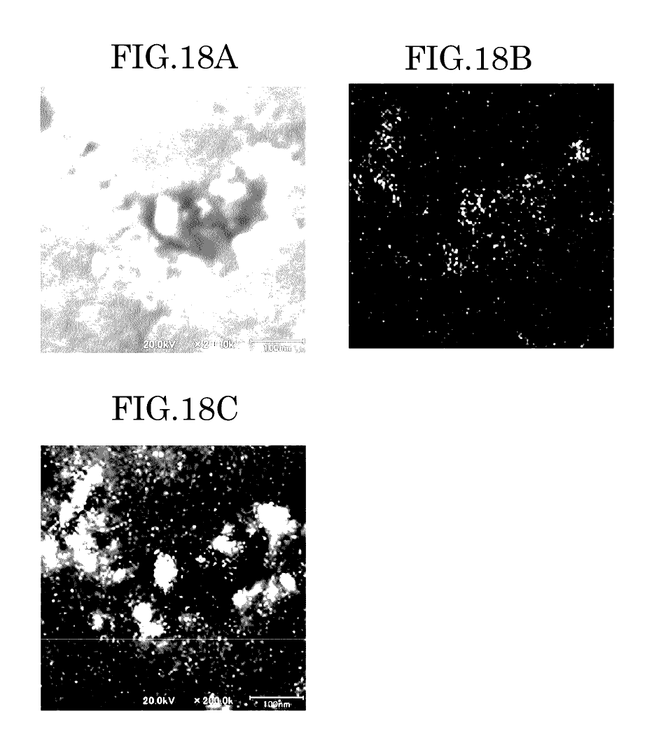

FIGS. 18A to 18C are diagrams showing an Al surface distribution of the outermost surface of a Cu substrate. FIG. 18A is a SEM image (200,000 times magnification) of the outermost surface of the Cu substrate subjected to AES. FIG. 18B is an Al surface distribution image by AES. FIG. 18C is a view obtained by superposing FIG. 18B on FIG. 18A. From the results in FIGS. 18A to 18C, it was clear that peaks corresponding to Al in the entire Cu substrate were detected, and it was clear that an infinite number of alumina particles are dispersed. From these results it was clear that it is possible to adhere an infinite number of nanometer sized alumina fine particles to a metal substrate surface by a fine powder shot process using the alumina powder to a Cu substrate.

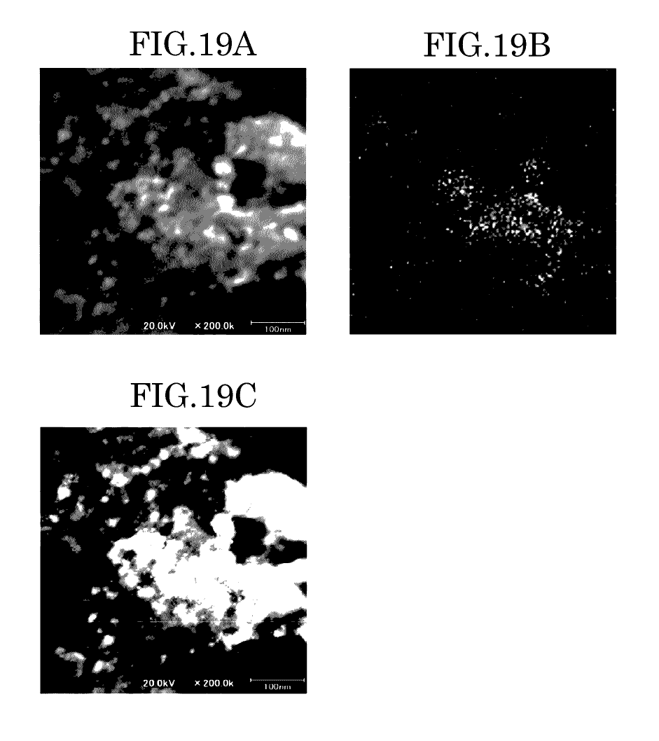

FIGS. 19A to 19C are diagrams showing an Al surface distribution of the outermost surface of a W substrate. FIG. 19A is a SEM image (200,000 times magnification) of the outermost surface of the W substrate subjected to AES. FIG. 19B to 19C is an Al surface distribution image by AES. FIG. 19C is a view obtained by superposing FIG. 19B on FIG. 19A. From the results in FIGS. 19A to 19C, it was clear that peaks corresponding to Al in the entire W substrate were detected, and it was clear that an infinite number of alumina particles are dispersed. From these results it was clear that it is possible to adhere an infinite number of nanometer sized alumina fine particles to a metal substrate surface by a fine powder shot process using the alumina powder to a W substrate.

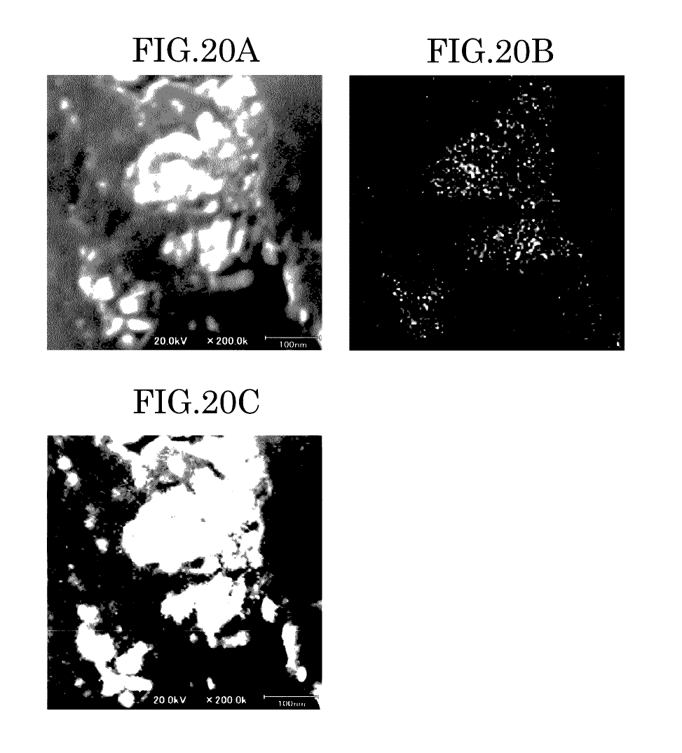

FIGS. 20A to 20C are diagrams showing an Al surface distribution of the outermost surface of a Ti substrate. FIG. 20A is a SEM image (200,000 times magnification) of the outermost surface of the Ti substrate subjected to AES. FIG. 20B is an Al surface distribution image by AES. FIG. 20C is a view obtained by superposing FIG. 20B on FIG. 20A. From the results in FIGS. 20A to 20C, it was clear that peaks corresponding to Al in the entire Ti substrate were detected, and it was clear that an infinite number of alumina particles are dispersed. From these results it was clear that it is possible to adhere an infinite number of nanometer sized alumina fine particles to a metal substrate surface by a fine powder shot process using the alumina powder to a Ti substrate.

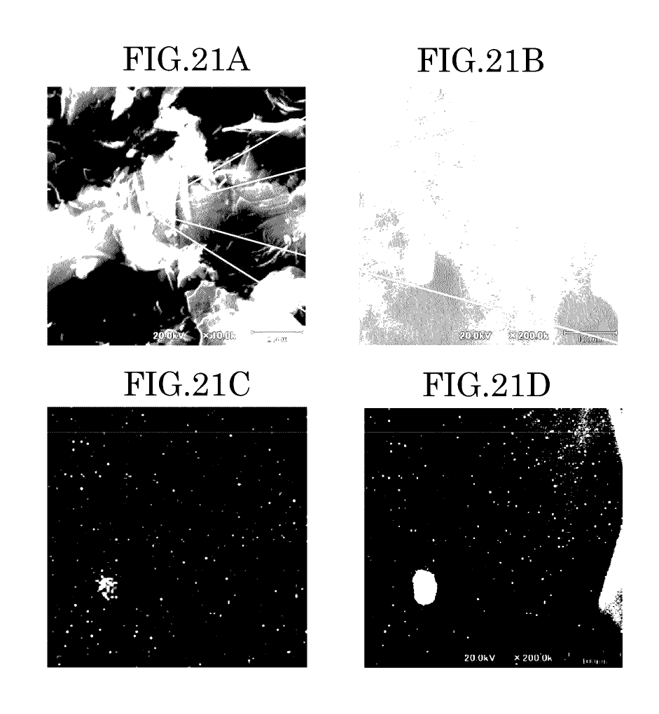

FIGS. 21A to 21D are diagrams showing an Al surface distribution of the outermost surface of an isotropic graphite (IG110) substrate. FIG. 21A is a SEM image (10,000 times magnification) of the isotropic graphite substrate. FIG. 21B is a SEM image of the outermost surface of the isotropic graphite substrate subjected to AES in FIG. 21A (200,000 times magnification). FIG. 21C is an Al surface distribution image by AES. FIG. 21D is a view obtained by superposing FIG. 21C on FIG. 21B. From the results in FIGS. 21A to 21D, it was clear that peaks corresponding to Al in the entire isotropic graphite substrate were detected, and it was clear that an infinite number of alumina particles are dispersed. From these results it was clear that it is possible to adhere an infinite number of nanometer sized alumina fine particles to a metal substrate surface by a fine powder shot process using the alumina powder to a isotropic graphite substrate.

### [Formation of a Carbon Nanostructure]

A substrate was placed into a in a quartz tube of a CVD reaction furnace, after placing a ceramic boat containing a powder of ferrocene of a catalyst precursor at the upstream end of the quartz tube, constant pressure (about 0.02 MPa) in the quartz tube was maintained, and a constant flow of nitrogen gas (200 mL/min) and acetylene gas (10 mL/min) was introduced from upstream while exhausting at an appropriate exhaust speed from downstream. After confirming that a stable pressure was maintained, the quartz tube was heated for about 20 minutes to about 750° C. which is a synthesis temperature of a carbon nanotube. At this time, the ferrocene sublimated by heating in a preheating stage (100° C. to 200° C.) before the start of the CVD to form a catalyst metal particle layer (iron particle layer). In addition, the temperature of the substrate was maintained at about 750° C. which is the thermal decomposition temperature of the acetylene, and a carbon nanostructure was grown on the substrate surface.

### [SEM Observation and Raman Spectroscopic Analysis of a Carbon Nanostructure]

With regards to all of the sixteen types of metal substrates and two types of the inorganic carbon (isotropic graphite, glassy carbon) on which CVD was performed, as a result of visually confirming the presence and distribution of a carbon nanostructure which is a black substance, a black material considered to be a carbon nanostructure grew on all the metal substrates. In the present embodiment, HPG-510 manufactured by Toyo Tanso was used as the isotropic graphite and GC-20SS manufactured by Tokai Carbon was used as the glassy carbon. However, with respect to SUS304, it is considered that there is a possibility iron contained in the substrate itself acted as a catalyst metal unlike the other thirteen types of metals as is inferred from L. Randall et al., Carbon, 41, 659-672 (2003), and it cannot be affirmed that the carbon nanostructure was grown only by the effect of the present invention.

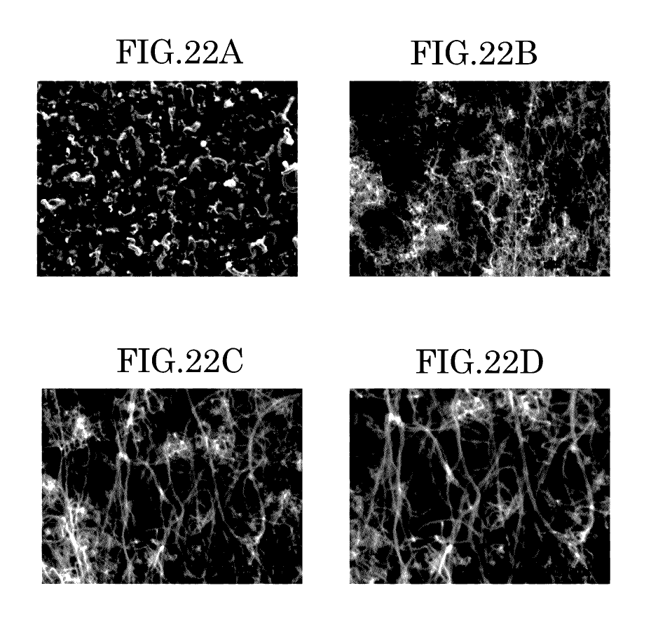

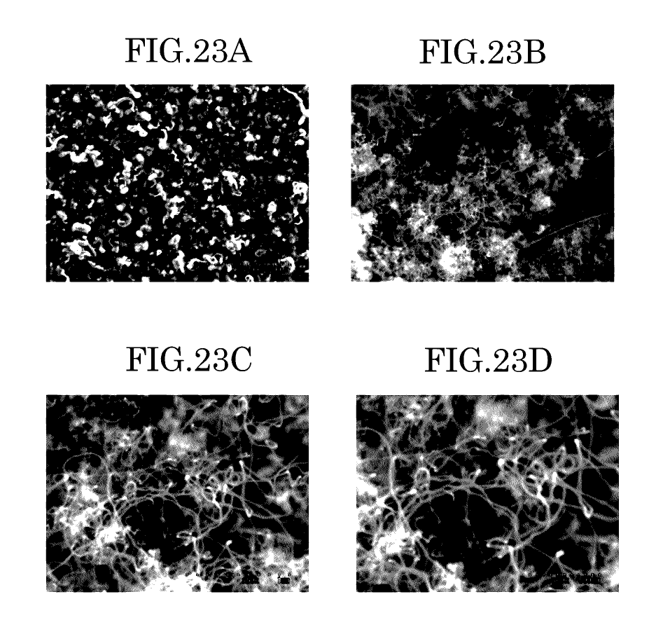

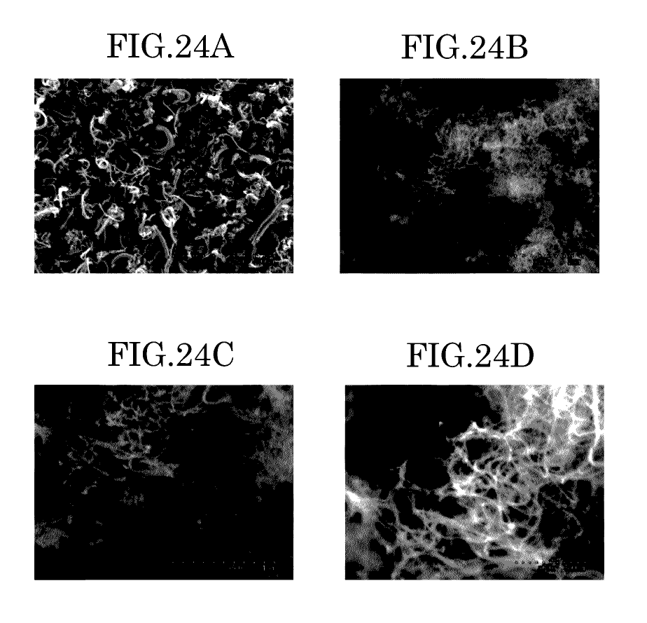

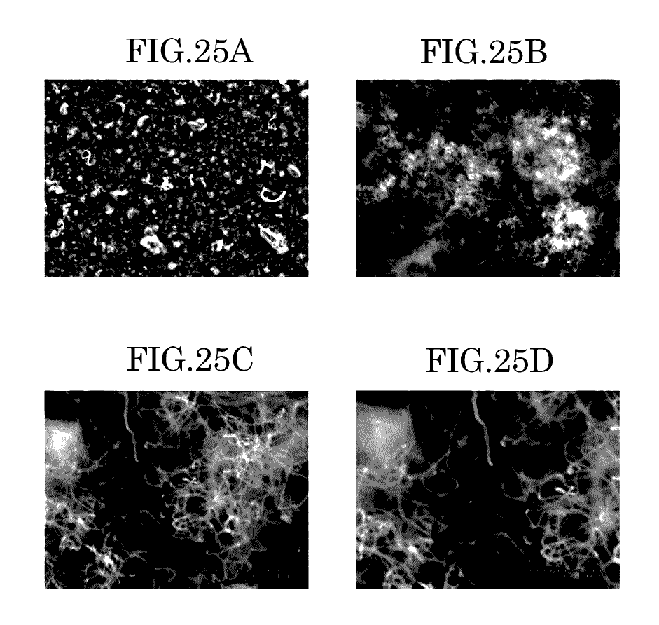

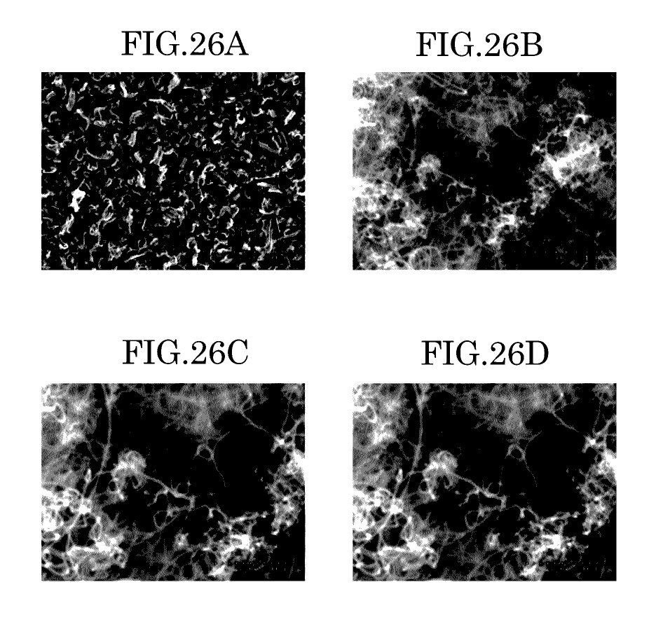

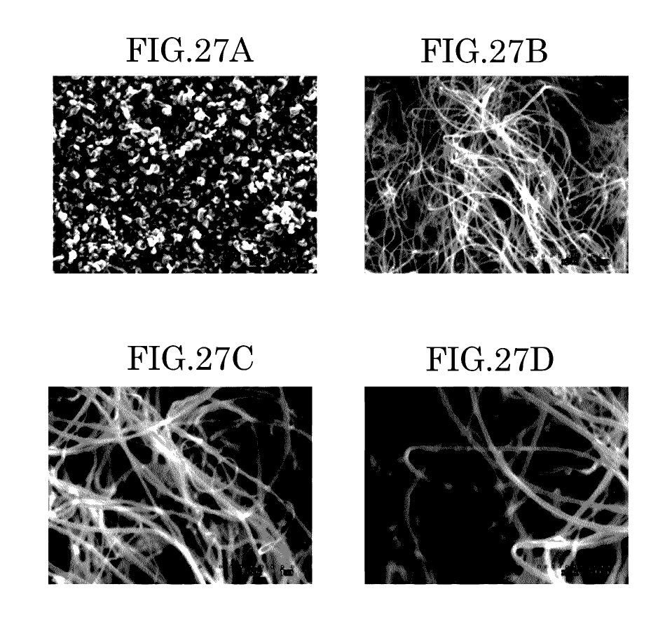

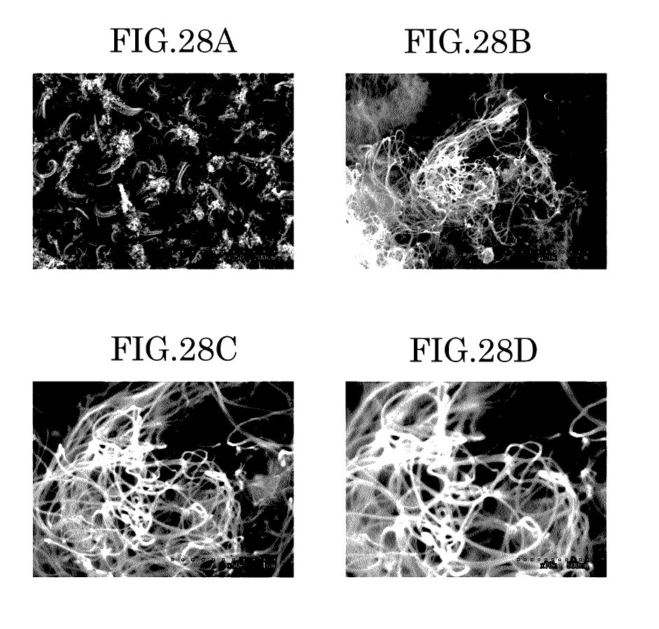

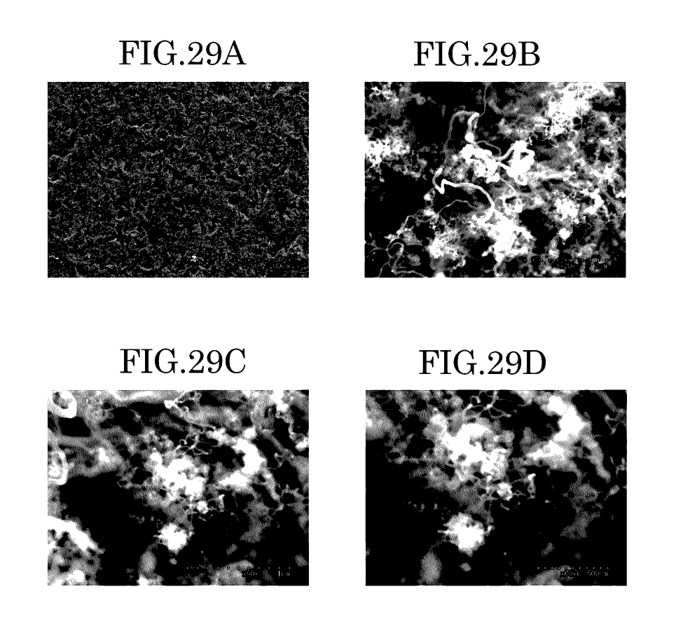

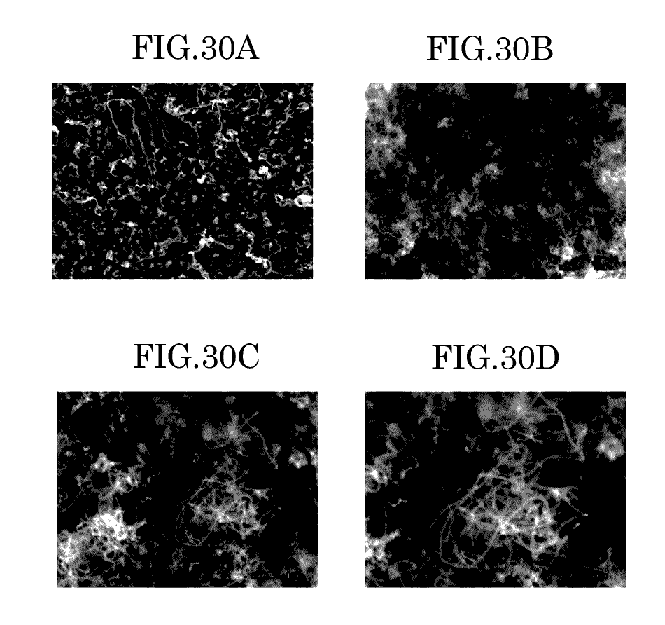

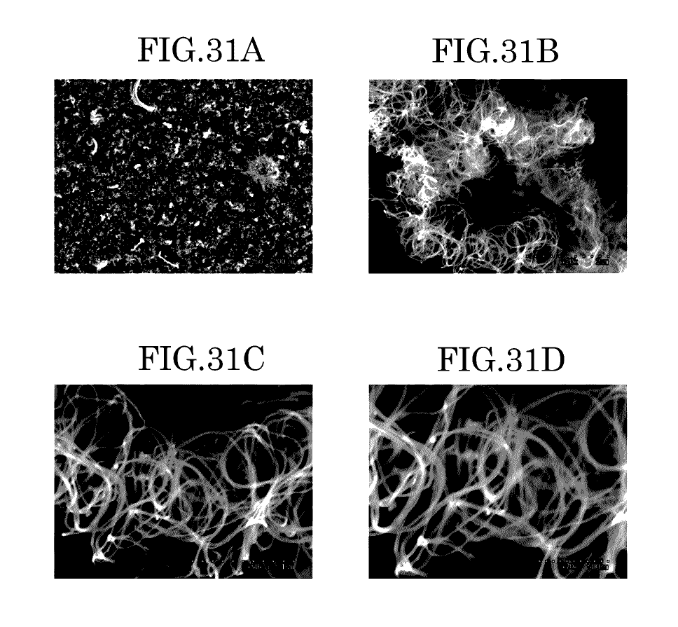

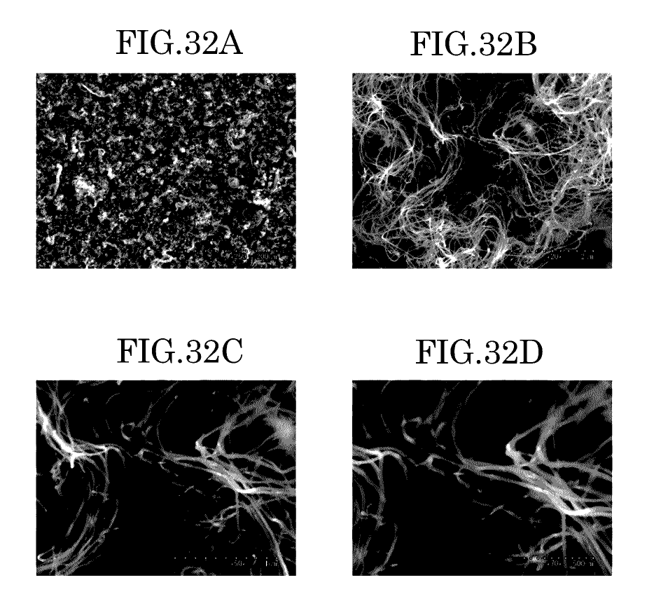

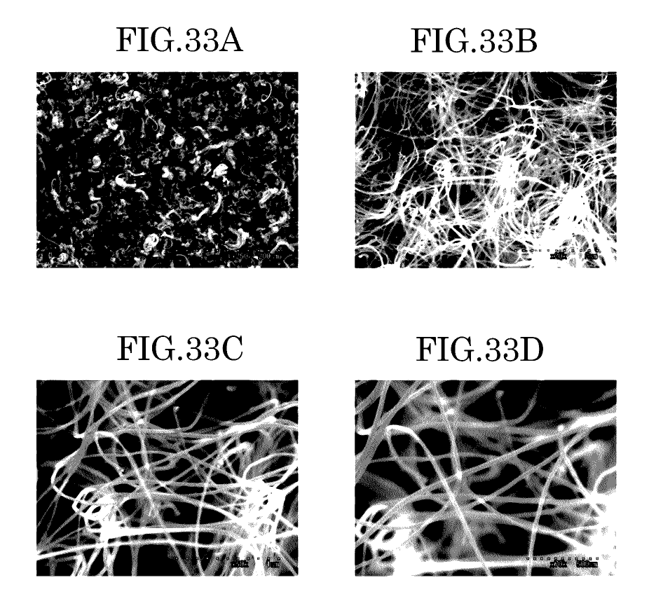

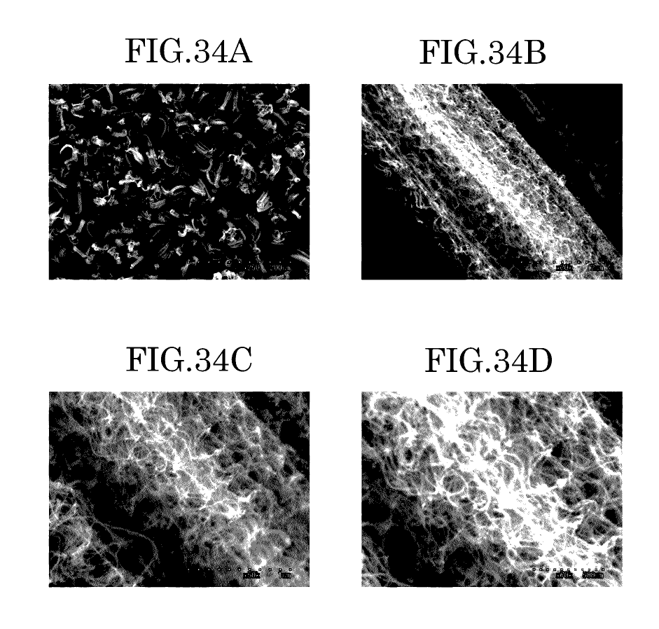

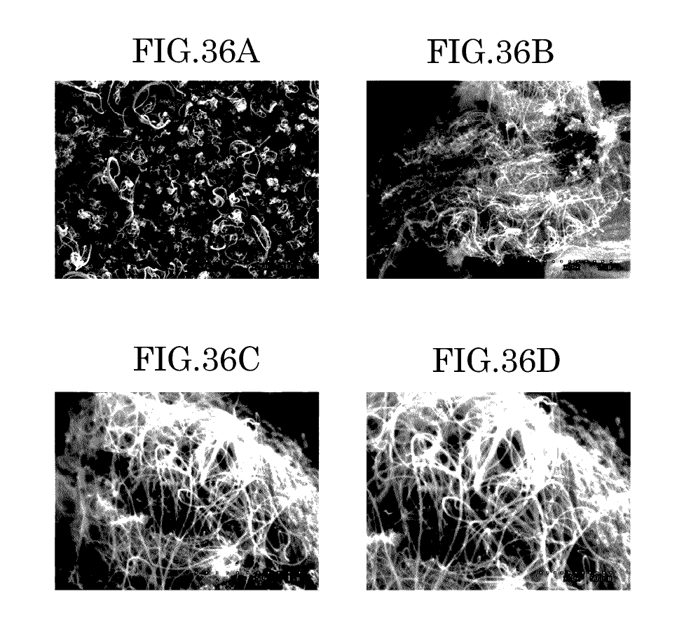

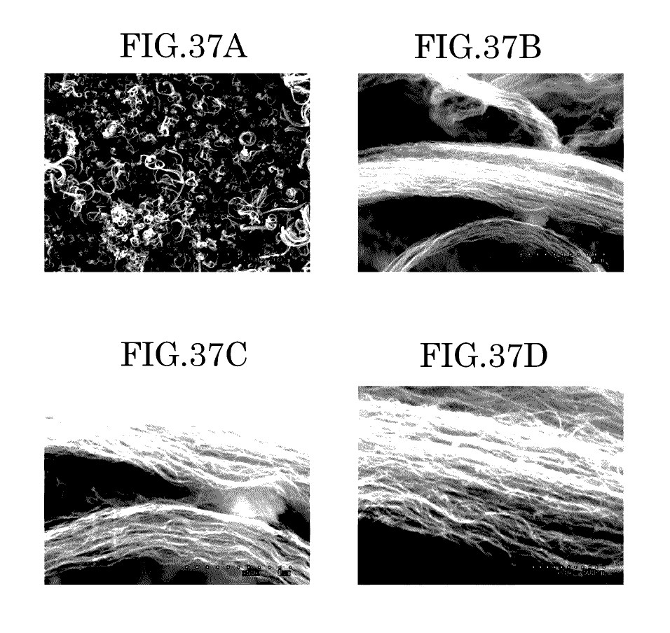

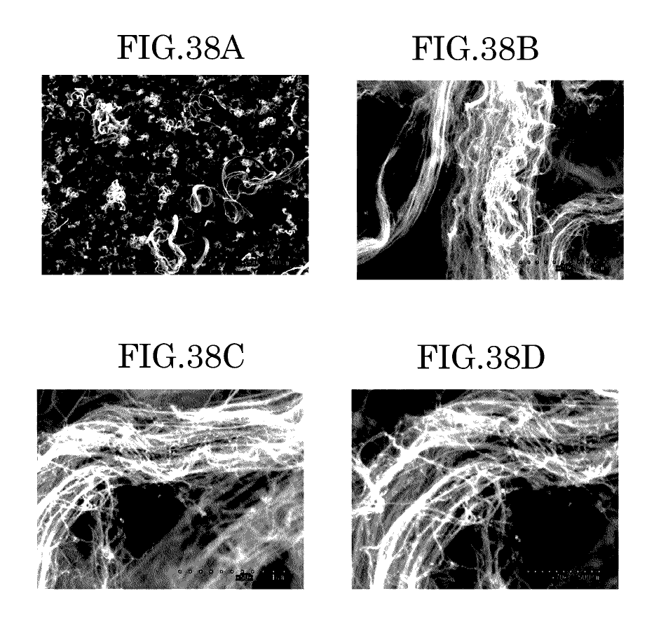

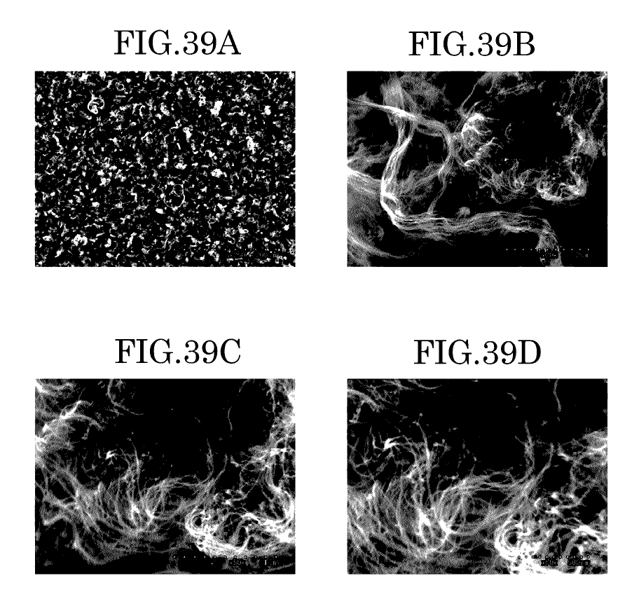

With respect to all of the sixteen types of metal substrate and two types of inorganic carbon (isotropic graphite, glassy carbon), a surface grow with a carbon nanostructure was observed by SEM. The observation results are shown in FIGS. 22A to 39D. In FIGS. 22A to 39D, four types of SEM image with different magnifications are shown for approximately the same location on the same sample surface. In each figure, diagrams were placed in order of photographs A to D to show 250 times, 2 thousand times, 50,000 times and 70,000 times magnification. From the results of these SEM observations, in the present embodiment, it was clear that a fibrous object having a diameter of about 10 to 50 nm is randomly dense on the metal surface. However, since irregularities are present in the growth surface and that it is likely that a smaller carbon nanostructure may not be detected by SEM, the non-existence of a carbon nanostructure of 10 nm or less, that is single-walled CNT, is not something which can be ensured.

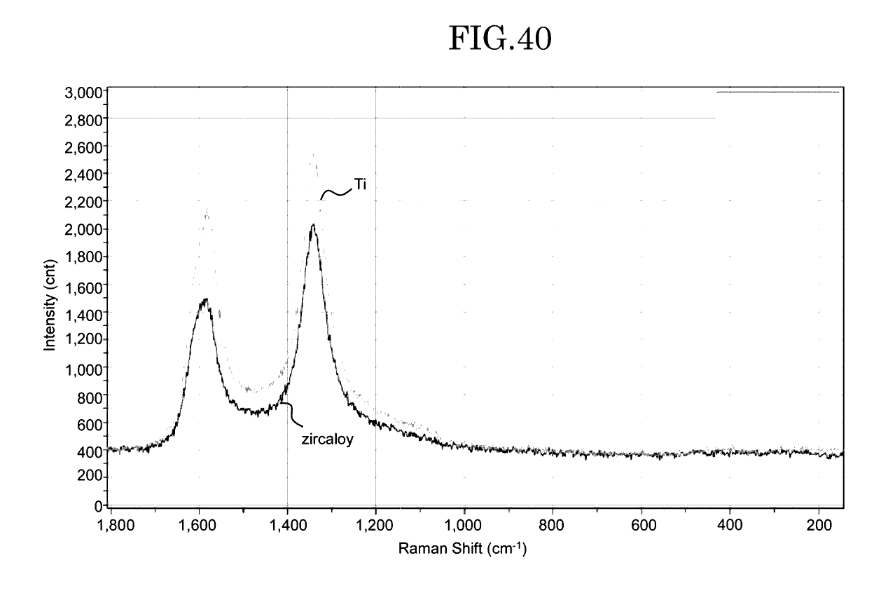

Therefore, a Raman spectroscopic analysis on the surface of a sample grown with a carbon nanostructure using the same method was performed on a Ti and zircaloy substrate. The obtained Raman spectrum is shown in FIG. 40. Although a G-band peak (in the vicinity of 1590 cm⁻¹) derived from a carbon and a D-band peak (in the vicinity of 1350 cm⁻¹) derived from defects were detected in both samples, RBM (Radial Breathing Mode; peaks of 300 cm⁻¹ or less) specific to a single-walled CNT were not detected.

An observation was performed by a transmission electron microscope (TEM) after performing a dispersion treatment after scraping carbon nanostructures grown on substrates such as Zr, Au, an isotropic graphite and glassy carbon from the substrate. H-9000NAR manufactured by Hitachi High-Technologies was used as the transmission electron microscope, and an acceleration voltage was 200 kV, total magnification was 2,050,000 times, and magnification accuracy was ±10%.

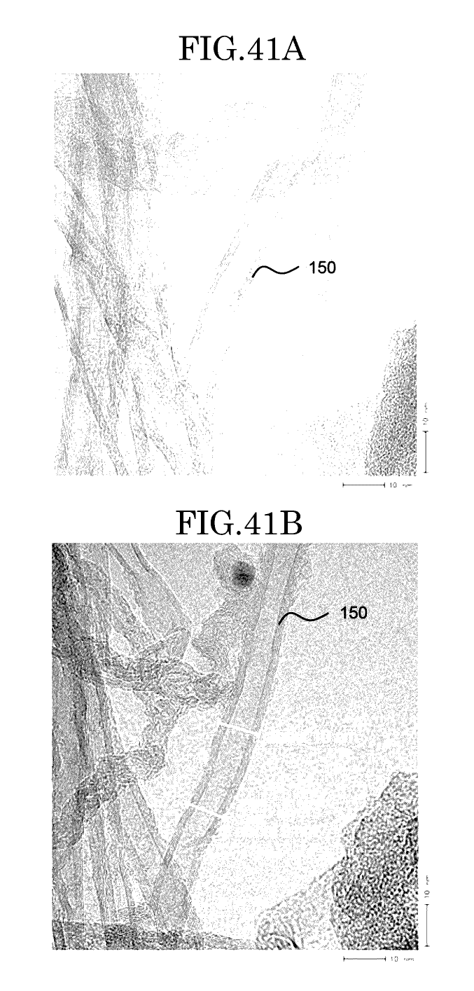

FIGS. 41A and 41B are TEM images of a carbon nanostructure grown on a Zr substrate related to the present example, and it was clear that generally a multi-layer CNT with a diameter of 9 to 10 nm having 4 to 7 layers of graphene are present. In the case when ferrocene is used as the catalyst precursor and acetylene as a raw material gas, it is empirically known that multilayer CNTs with a diameter of 5 to 30 nm are easily produced which is consistent with the results of the present example.

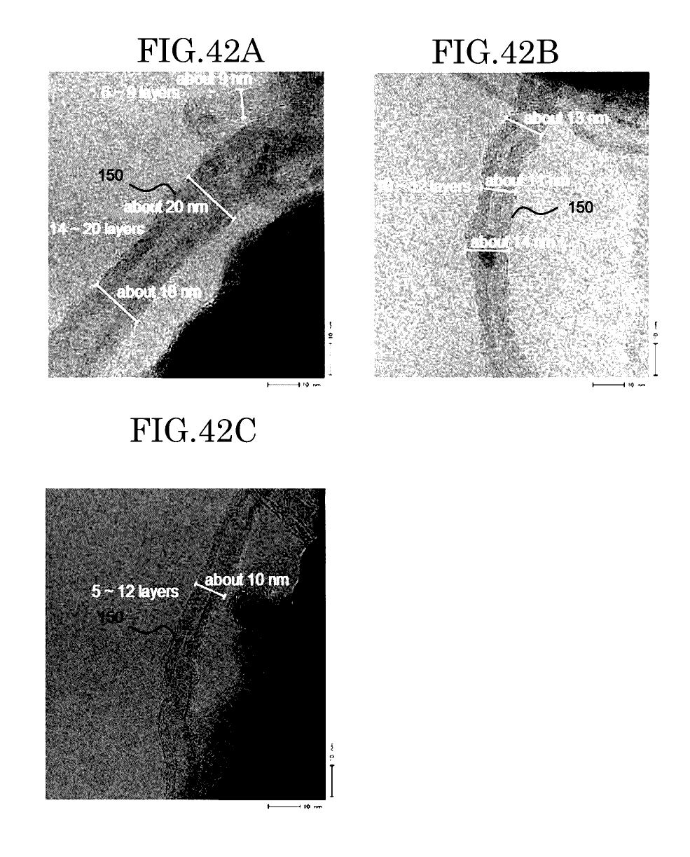

FIGS. 42A to 42C are TEM images of the carbon nanostructure grown on an Au substrate related to the present example. It was clear that multi-layer CNTs with a diameter of 9 to 20 nm having about 5 to 21 layers of graphene are present.

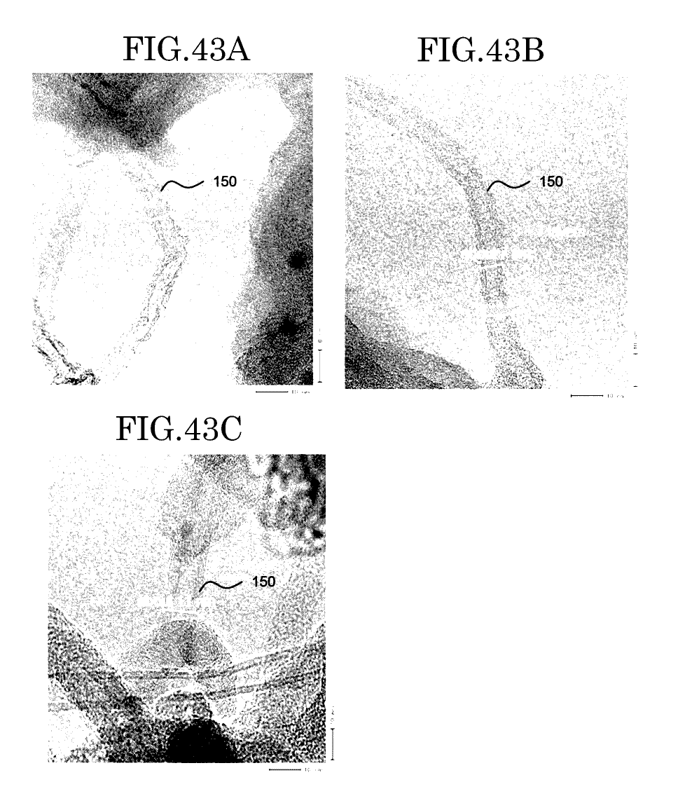

FIGS. 43A to 43C are TEM images of a carbon nanostructure grown on an isotropic graphite substrate related to the present example. It was clear that multi-layer CNTs with a diameter of 7 to 11 nm having about 2 to 8 layers of graphene are present.

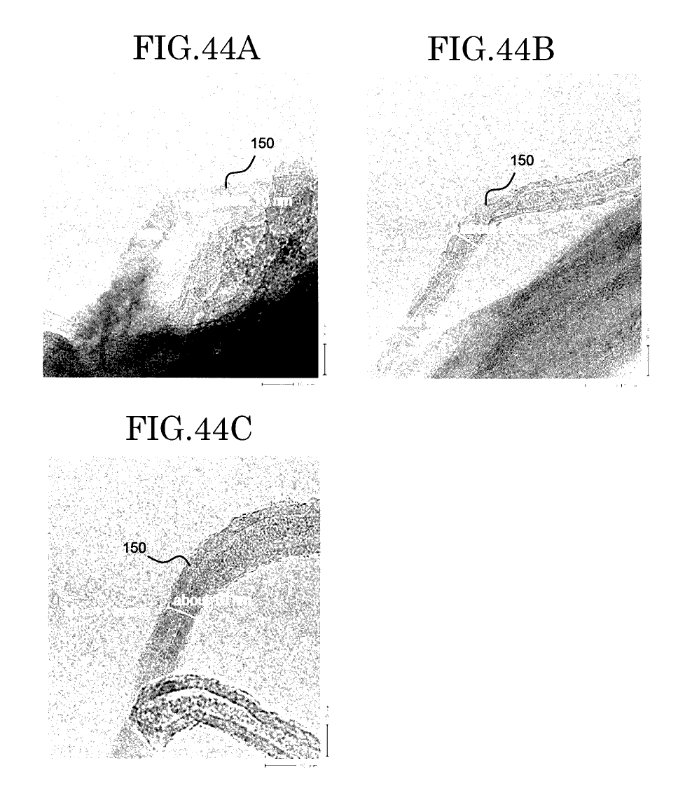

FIGS. 44A to 44C are TEM images of a carbon nanostructure grown on an glassy carbon (Tokai Carbon, GC20SS) substrate related to the present example. It was clear that multi-layer CNTs with a diameter of 9 to 11 nm having about 4 to 11 layers of graphene are present.

Considering the results of the electron microscope observation results and the Raman spectroscopic analysis results, the black-like carbon nanostructures grown on the surface of the substrate are considered to be multilayer CNTs or a thin CNF (diameter of the CNF is 50 to 200 nm).

### [Emissivity Measurement]

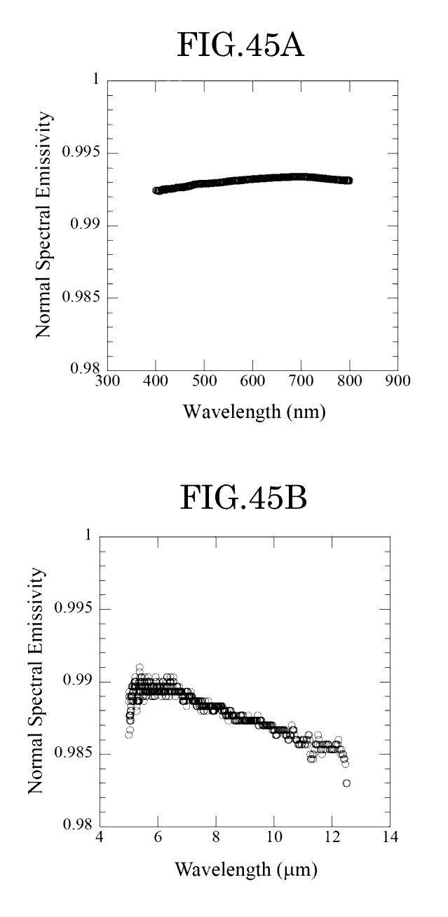

The results of a spectral emissivity measurement in the visible range and infrared range of carbon nanostructures grown on a Zr substrate performed as part of a performance evaluation of an optical member are shown in FIGS. 45A and 45B. FIG. 45A shows a vertical spectral emissivity spectra in the visible wavelength range (400 to 800 nm) at room temperature obtained from a comparative measurement of the hemispherical diffuse reflection intensity of a sample and 2% of a standard reflecting plate using an integrating sphere with a light source and a diffraction grating type multi-channel spectroscope. FIG. 45B shows a vertical spectral emissivity spectra in the infrared wavelength range (5 to 12 μm) calculated from a comparison of infrared spectrum intensity at a temperature of 373K of a black body and a sample using a Fourier transform infrared spectrophotometer (FTIR). Both spectra were obtained from an average of three measurements.

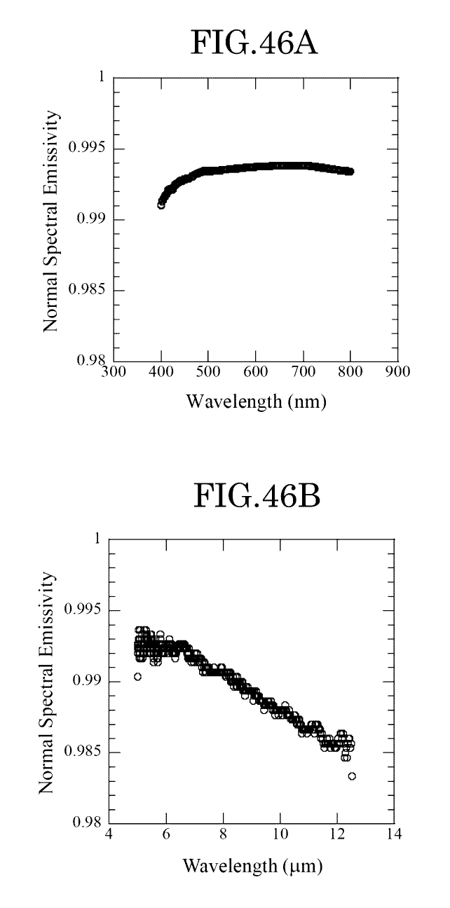

In addition, a spectral emissivity measurement in the visible range and infrared range of carbon nanostructures grown on a Ti substrate is shown in FIGS. 46A and 46B. FIG. 46A shows a vertical spectral emissivity spectra in the visible wavelength range (400 to 800 nm) at room temperature obtained from a comparative measurement of the hemispherical diffuse reflection intensity of a sample and 2% of a standard reflecting plate using an integrating sphere with a light source and a diffraction grating type multi-channel spectroscope. FIG. 46B shows a vertical spectral emissivity spectra in the infrared wavelength range (5 to 12 μm) calculated from a comparison of infrared spectrum intensity at a temperature of 373K of a black body and a sample using a Fourier transform infrared spectrophotometer (FTIR).

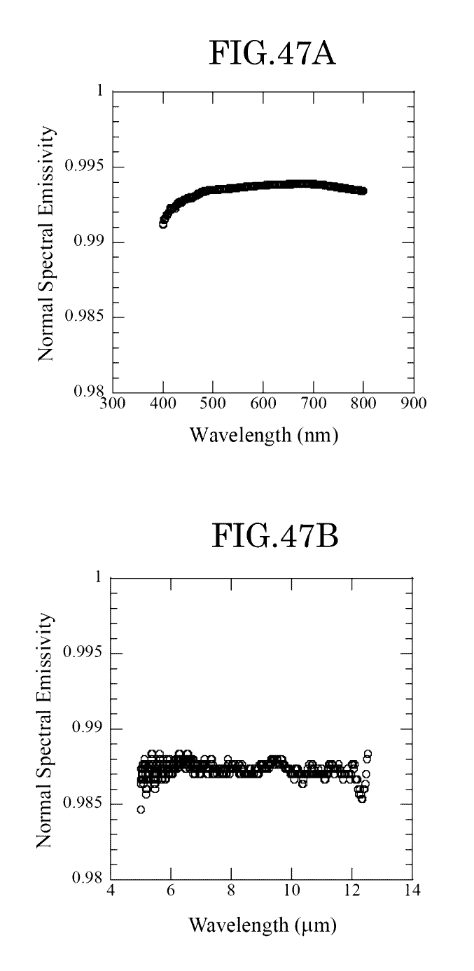

In addition, a spectral emissivity measurement in the visible range and infrared range of carbon nanostructures grown on a Zircaloy substrate is shown in FIGS. 47A and 47B. FIG. 47A shows a vertical spectral emissivity spectra in the visible wavelength range (400 to 800 nm) at room temperature obtained from a comparative measurement of the hemispherical diffuse reflection intensity of a sample and 2% of a standard reflecting plate using an integrating sphere with a light source and a diffraction grating type multi-channel spectroscope. FIG. 47B shows a vertical spectral emissivity spectra in the infrared wavelength range (5 to 12 μm) calculated from a comparison of infrared spectrum intensity at a temperature of 373K of a black body and a sample using a Fourier transform infrared spectrophotometer (FTIR).

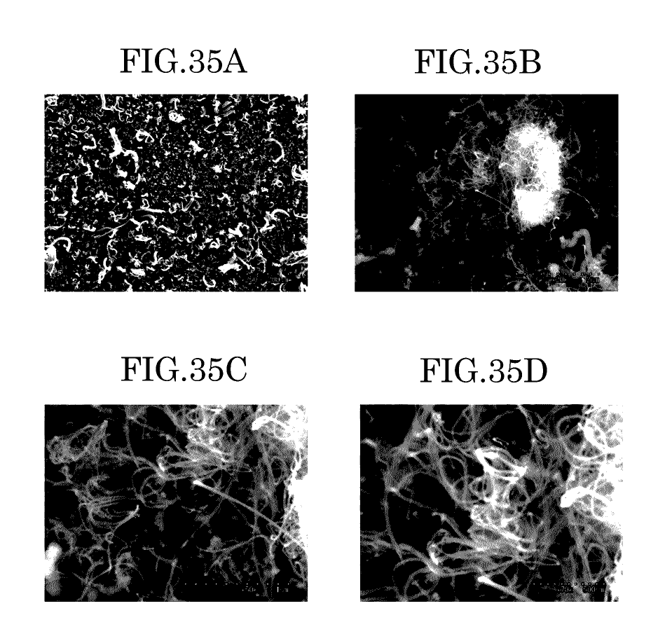

From FIGS. 35A to 47D, considering a spectral emissivity of 0.99 or more in the visible wavelength range, a spectral emissivity of 0.98 or more in the infrared wavelength range, and an effective emissivity of a commercial plane blackbody furnace of at most 0.95, it was clear that the optical member related to the present example is an optical member of unprecedented high performance.

According to the present invention, it is possible to provide an optical member and a producing method thereof which can uniformly grow a carbon nanostructure having high emissivity on a surface of an object with no significant restrictions with respect to material or shape compared to a conventional technique.

1. An optical member comprising:
a metal substrate or inorganic carbon substrate having a rough surface on at least a part, and the metal substrate or inorganic carbon substrate does not melt at a growth temperature of a carbon nanostructure,
an inorganic material layer containing inorganic fine particles comprised from a metal oxide and the inorganic material layer being formed on the rough surface of the metal substrate or the inorganic carbon substrate;
a catalyst metal fine particle layer supported on the inorganic material layer; and
a carbon nanostructure formed on the catalyst metal fine particle layer.

2. The optical member according to claim 1, wherein a material of the metal substrate is a metal selected from a group comprising of Ti, Zr, Hf, V, Nb, Ta, Cr, Mo, W, Pd, Pt, Cu, Au and Ag or an alloy of these as a main component, and a material of the inorganic carbon substrate is an isotropic graphite or glassy carbon.

3. The optical member according to claim 2, wherein the inorganic material layer includes an oxide film of a metal substrate itself formed in the metal substrate.

4. The optical member according to claim 1, wherein spectral emissivity in the visible wavelength range is 0.99 or more, and spectral emissivity in the infrared wavelength range is 0.98 or more.

5. The optical member according to claim 2, wherein spectral emissivity in the visible wavelength range is 0.99 or more, and spectral emissivity in the infrared wavelength range is 0.98 or more.

6. The optical member according to claim 3, wherein spectral emissivity in the visible wavelength range is 0.99 or more, and spectral emissivity in the infrared wavelength range is 0.98 or more.

7. A producing method for an optical member comprising:
forming a rough surface by colliding inorganic fine particles comprising a metal oxide using an aerodynamic or projection method on at least a part of a metal substrate or inorganic carbon substrate which does not melt at a growth temperature of a carbon nanostructure, and forming an inorganic layer on the rough surface of the metal substrate or inorganic carbon substrate;
forming a catalyst metal fine particle layer on the inorganic layer; and
forming a carbon nanostructure on the catalytic metal fine particle layer.

8. A producing method for an optical member comprising:
forming a rough surface by colliding inorganic fine particles comprising a metal oxide using an aerodynamic or projection method on at least a part of a metal substrate or inorganic carbon substrate which does not melt at a growth temperature of a carbon nanostructure;
forming an inorganic material layer mixed with an oxide film of the metal substrate itself and an inorganic fine particle layer;
forming a catalyst metal fine particle layer on the inorganic layer; and
forming a carbon nanostructure on the catalyst metal fine particle layer.

9. The producing method for an optical member according to claim 7, wherein the catalyst metal fine particle layer is formed by supplying a vapor containing catalyst metal fine particles generated by heating a metal complex.

10. The producing method for an optical member according to claim 8, wherein the catalyst metal fine particle layer is formed by supplying a vapor containing catalyst metal fine particles generated by heating a metal complex.
